(19) United States
(12) Patent Application Publication
(10) Pub. No.: US 2013/0208805 A1
(43) Pub. Date: Aug. 15, 2013

(54) IMAGE PROCESSING DEVICE AND IMAGE PROCESSING METHOD

(71) Applicant: Kazushi Sato, Kanagawa (JP)

(72) Inventor: Kazushi Sato, Kanagawa (JP)

(21) Appl. No.: 13/880,256

(22) PCT Filed: Oct. 17, 2011
(86) PCT No.: PCT/JP2011/073809

§ 371 Date: Apr. 18, 2013

(30) Foreign Application Priority Data
Oct. 25, 2010 (JP) 2010-238351

(51) Int. Cl. H04N 7/26

(52) U.S. Cl. CPC H04N 19/00733
USPC 375/240.16

(57) ABSTRACT

A high encoding efficiency is to be realized. A block selection processing unit 33 selects a block from adjacent motion compensation blocks, in accordance with the block size of the motion compensation block being encoded and the block sizes of the encoded adjacent motion compensation blocks adjacent to this motion compensation block. A predicted motion vector information generation unit 34 generates predicted motion vector information about the motion compensation block being encoded, by using the motion vector information about the selected block. A motion prediction/compensation unit 32 performs an inter prediction by using the predicted motion vector information generated at the predicted motion vector information generation unit 34, and generates predicted image data.

### TECHNICAL FIELD

This technique relates to an image processing device and an image processing method. Particularly, this technique provides an image processing device and an image processing method that can realize a high encoding efficiency even when macroblocks with extended sizes are used.

### BACKGROUND ART

In recent years, apparatuses that handle image information as digital information and achieve high-efficiency information transmission and accumulation in doing so, or apparatuses compliant with a standard such as MPEG for compression through orthogonal transforms like discrete cosine transforms and motion compensations, have been spreading among broadcast stations and general households.

Particularly, MPEG2 (ISO/IEC 13818-2) is defined as a general-purpose image encoding technique, and is currently used for a wide range of applications for professionals and general consumers. By using the MPEG2 compression technique, a bit rate of 4 to 8 Mbps is assigned to a standard-resolution interlaced image having 720×480 pixels, for example. Also, a bit rate of 18 to 22 Mbps is assigned to a high-resolution interlaced image having 1920×1088 pixels. Through such bit rate assignments, a high compression rate and excellent image quality can be realized.

Although a larger amount of calculation than that of a conventional encoding technique such as MPEG2 is required in encoding and decoding, standardization to realize a high encoding efficiency was conducted under the name of Joint Model of Enhanced-Compression Video Coding, which has become international standards as H.264 and MPEG-4 Part 10 (hereinafter referred to as “H.264/AVC (Advanced Video Coding)”).

In H.264/AVC, a macroblock formed with 16×16 pixels is divided into 16×16, 16×8, 8×16, or 8×8 pixel motion compensation blocks that can have motion vector information independently of one another, as shown in FIG. 1. Each 8×8 pixel sub-macroblock can be further divided into 8×8, 8×4, 4×8, or 4×4 pixel motion compensation blocks that can have motion vector information independently of one another, as shown in FIG. 1. In MPEG-2, the unit in motion prediction/compensation operations is 16×16 pixels in a frame motion compensation mode, and is 16×8 pixels in each of a first field and a second field in a field motion compensation mode.

In H.264/AVC, such motion prediction/compensation operations are performed. As a result, an enormous amount of motion vector information is generated, and encoding the motion vector information as it is will lead to a decrease in encoding efficiency.

To solve this problem, the median prediction described below is used in H.264/AVC, and a decrease in the amount of encoded motion vector information is realized.

In FIG. 2, a block E is the motion compensation block that is about to be encoded, and blocks A through D are already encoded motion compensation blocks adjacent to the motion compensation block E.

Here, X is A, B, C, D, or E, and mvX represents the motion vector information about a motion compensation block X.

By using the motion vector information about the motion compensation blocks A, B, and C, predicted motion vector information pmvE about the motion compensation block E is generated through a median prediction according to the equation (1).

pmvE=med(mvA,mvB,mvC) (1)

If the information about the adjacent motion compensation block C cannot be obtained because the block C is located at a corner of the image frame or the like, the information about the adjacent motion compensation block D is used instead.

In the compressed image information, the data mvdE to be encoded as the motion vector information about the motion compensation block E is generated by using pmvE according to the equation (2).

mvdE=mvE−pmvE (2)

In an actual operation, processing is performed on the horizontal component and the vertical component of the motion vector information independently of each other.

Also, in H.264/AVC, a multi-reference frame technique is specified. Referring now to FIG. 3, the multi-reference frame technique defined in H.264/AVC is described.

In MPEG2 or the like, in the case of a P-picture, a motion prediction/compensation operation is performed by referring only one reference frame stored in a frame memory. In H.264/AVC, however, more than one reference frame is stored in memories, so that a different memory can be referred to for each block, as shown in FIG. 3.

Although the amount of motion vector information in a B-picture is very large, there is a predetermined mode called the direct mode in H.264/AVC. In the direct mode, motion vector information is not contained in compressed image information, and a decoding device extracts the motion vector information about the block from the motion vector information about a surrounding or anchor block (Co-Located Block). The anchor block is the block that has the same x-y coordinates in a reference image as the motion compensation block being encoded.

The direct mode includes a spatial direct mode and a temporal direct mode, and one of the two modes can be selected for each slice.

In the spatial direct mode, motion vector information pmvE generated through a median prediction is used as the motion vector information mvE to be used for the block, as shown in the equation (3).

mvE=pmvE (3)

Referring now to FIG. 4, the temporal direct mode is described. In FIG. 4, the block located at the same spatial address in an L0 reference picture as the block is the anchor block, and the motion vector information about the anchor block is motion “mvcol”. Also, “TDB” represents the distance on the temporal axis between the picture and the L0 reference picture, and “TDD” represents the distance on the temporal axis between the L0 reference picture and an L1 reference picture. In this case, L0 motion vector information mvL0 and L1 motion vector information mvL1 in the picture are calculated according to the equations (4) and (5).

mvL0=(TDB/TDD)mvcol (4)

mvL1=((TDD−TDB)/TDD)mvcol (5)

In the compressed image information, information indicating a distance on the temporal axis does not exist, and therefore, the calculations according to the equations (4) and (5) use POC (Picture Order Count).

In AVC compressed image information, the direct mode can be defined with a 16×16 pixel macroblock unit or an 8×8 pixel sub-macroblock unit.

Meanwhile, Non-Patent Document 1 has suggested an improvement in the motion vector encoding that uses a median prediction as shown in FIG. 2. According to Non-Patent Document 1, temporally predicted motion vector information or spatiotemporally predicted motion vector information can be adaptively used as well as spatially predicted motion vector information obtained through a median prediction.

That is, in FIG. 5, the motion vector information mvcol is the motion vector information about the anchor block with respect to the motion compensation block. Also, motion vector information mvtk (k=0 through 8) is the motion vector information about the surrounding blocks.

Temporally predicted motion vector information mvtm is generated from five pieces of motion vector information by using the equation (6). Alternatively, the temporally predicted motion vector information mvtm may be generated from nine pieces of motion vector information by using the equation (7).

mvtm5=med(mvcol,mvt0, . . . mvt3) (6)

mvtm9=med(mvcol,mvt0, . . . mvt7) (7)

Spatiotemporally predicted motion vector information mvspt is generated from five pieces of motion vector information by using the equation (8).

mvspt=med(mvcol,mvcol,mvA,mvB,mvC) (8)

In an image processing device that encodes image information, cost function values for respective blocks are calculated by using the predicted motion vector information about the respective blocks, and optimum predicted motion vector information is selected. Through the compressed image information, a flag indicating the information about which predicted motion vector information has been used is transmitted for each block.

Also, there is an increasing demand for encoding at a higher compression rate so as to compress 4000×2000 pixels images and the like, or distribute high-definition images in today's circumstances where transmission capacities are limited as in the Internet. In view of this, Non-Patent Document 2 discloses the use of extended macroblocks in a hierarchical structure in which the sizes of the macroblocks are made larger than those in MPEG2 or H.264/AVC. That is, in an extended macroblock, 16×16 pixel blocks and smaller blocks are compatible with the macroblocks in H.264/AVC. As the supersets of those blocks, larger blocks such as 32×32 pixel macroblocks are defined.

### CITATION LIST

### Non-Patent Documents

Non-Patent Document 1: “Motion Vector Coding with Optimal PMV Selection” (Video Coding Experts Group (VCEG), Study Group 16, ITU, VCEG-AI22, July 2008)
Non-Patent Document 2: “Video Coding Using Extended Block Sizes” (Study Group 16, Contribution 123, ITU, COM16-C123-E, January 2009)

### SUMMARY OF THE INVENTION

### Problems to be Solved by the Invention

As shown in FIG. 6, when the motion compensation block being encoded and the left-side adjacent motion compensation block are 16×16 pixel blocks, and the upper and upper-right adjacent motion compensation blocks are 4×4 pixel blocks, the upper end of the motion compensation block is assumed to be the boundary between a random motion region and a still image region. In H.264/AVC, however, discontinuity that appears on motion boundaries is not taken into consideration when motion vector information is encoded. As a result, a median prediction is performed by using the motion vector information about adjacent motion compensation blocks in the random motion region and the still image region, and there is a possibility that predicted motion vectors for achieving a high encoding efficiency cannot be generated.

Further, when extended macroblocks are used as disclosed in Non-Patent Document 2, there are cases where the encoding efficiency can be increased by reducing the motion compensation block size in the random motion region and increasing the motion compensation block size in the still image region, for example. In such a case, the motion vector information difference becomes even larger between an encoding current motion compensation block located on a motion boundary and the adjacent motion compensation blocks adjacent to the encoding current motion compensation block via the motion boundary. Therefore, the use of predicted motion vectors generated through a median prediction will lead to an increase in the difficulty of achieving a high encoding efficiency.

In view of this, an object of this technique is to provide an image processing device and an image processing method that can realize a high encoding efficiency.

### Solutions to Problems

A first aspect of this technique lies in an image processing device that performs encoding or decoding by using motion compensation blocks defined in a hierarchical structure. This image processing device includes: a block selection processing unit that selects a block from adjacent motion compensation blocks, in accordance with the block size of a current motion compensation block being subjected to the encoding or decoding and the block sizes of the encoded adjacent motion compensation blocks adjacent to the current motion compensation block; and a predicted motion vector information generation unit that generates predicted motion vector information to be used in an encoding operation or an decoding operation for the motion vector information about the current motion compensation block, by using the motion vector information about the block selected by the block selection processing unit.

According to this technique, only the adjacent motion compensation block(s) encoded in a block size of the same hierarchical level as the current motion compensation block is selected in accordance with the block size of the current motion compensation block being encoded or decoded and the block sizes of the encoded adjacent motion compensation blocks adjacent to the current motion compensation block. Further, based on the motion vector information about the selected adjacent motion compensation block, the predicted motion vector information is generated.

When the adjacent motion compensation block located in the upper right position with respect to the current motion compensation block has been encoded in a block size of a different hierarchical level, the upper-left adjacent motion compensation block is used, instead of the upper-right adjacent motion compensation block. When all three of the three adjacent motion compensation blocks to be used in a median prediction have been encoded in block sizes of the same hierarchical level as the current motion compensation block, the median prediction is performed by using the motion vector information about the three adjacent motion compensation blocks, to generate the predicted motion vector information. When two blocks have been encoded in block sizes of the same hierarchical level, the mean value of the motion vectors indicated by the motion vector information about the two adjacent motion compensation blocks belonging to the same hierarchical level is calculated, and the motion vector information indicating the mean value or the motion vector information about one of the two adjacent motion compensation blocks is set as the predicted motion vector information. Further, when one block has been encoded in a block size of the same hierarchical level, the motion vector information about the one adjacent motion compensation block belonging to the same hierarchical level is set as the predicted motion vector information. When there are no adjacent motion compensation blocks belonging to the same hierarchical level, the predicted motion vector information indicates a zero-vector.

When the adjacent motion compensation blocks temporally adjacent to the current motion compensation block have sizes of the same resolution, the motion vector information about the temporally adjacent motion vector blocks is set as temporally predicted motion vector information, and the temporally predicted motion vector information or spatially predicted motion vector information generated based on the motion vector information about the three adjacent motion compensation blocks to be used in the median prediction is used as the predicted motion vector information. When only the spatially predicted motion vector information can be generated, or when only the temporally predicted motion vector information can be generated, the information that can be generated is used as the predicted motion vector information. Further, when neither the spatially predicted motion vector information nor the temporally predicted motion vector information can be generated, information indicating a zero-vector is used as the predicted motion vector information.

A second aspect of this technique lies in an image processing method for performing encoding or decoding by using motion compensation blocks defined in a hierarchical structure in an image processing device. This image processing method includes the steps of: selecting a block from adjacent motion compensation blocks, in accordance with the block size of a current motion compensation block being subjected to the encoding or decoding and the block sizes of the encoded adjacent motion compensation blocks adjacent to the current motion compensation block; and generating predicted motion vector information to be used in an encoding operation or an decoding operation for the motion vector information about the current motion compensation block, by using the motion vector information about the selected block.

### Effects of the Invention

According to this technique, a block is selected from adjacent motion compensation blocks, in accordance with the block size of a current motion compensation block being encoded or decoded and the block sizes of the encoded adjacent motion compensation blocks adjacent to the current motion compensation block. Also, predicted motion vector information about the current motion compensation block being processed is generated by using the motion vector information about the selected block. That is, predicted motion vector information is generated by adaptively using the motion vector information about an adjacent motion compensation block in accordance with the block sizes of the current motion compensation block being processed and the adjacent motion compensation blocks. Accordingly, predicted motion vector information can be generated in accordance with the result of detection of discontinuity appearing on a motion boundary, and a high encoding efficiency can be realized.

### BRIEF DESCRIPTION OF DRAWINGS

FIG. 1 is a diagram showing motion compensation blocks in H.264/AVC.

FIG. 2 is a diagram for explaining a median prediction.

FIG. 3 is a diagram for explaining the multi-reference frame technique.

FIG. 4 is a diagram for explaining the temporal direct mode.

FIG. 5 is a diagram for explaining temporally predicted motion vector information and spatiotemporally predicted motion vector information.

FIG. 6 is a diagram showing example sizes of a motion compensation block being encoded and encoded adjacent motion compensation blocks.

FIG. 7 is a diagram showing the structure of an image encoding device.

FIG. 8 is a diagram showing the structures of the motion prediction/compensation unit and the predicted motion vector generation unit.

FIG. 9 is a diagram for explaining a motion prediction/compensation operation with ¼ pixel precision.

FIG. 10 show a hierarchical structure where macroblock sizes are extended.

FIG. 11 is a flowchart showing an operation of the image encoding device.

FIG. 12 is a flowchart showing prediction operations.

FIG. 13 is a flowchart showing intra prediction operations.

FIG. 14 is a flowchart showing inter prediction operations.

FIG. 15 is a flowchart showing a predicted motion vector information generating operation.

FIG. 16 is a flowchart showing a predicted motion vector information generating operation using not only spatial blocks but also temporal blocks.

FIG. 17 is a diagram showing the structure of an image decoding device.

FIG. 18 is a diagram showing the structures of the motion compensation unit and the predicted motion vector generation unit.

FIG. 19 is a flowchart showing an operation of the image decoding device.

FIG. 20 is a flowchart showing a predicted image generating operation.

FIG. 21 is a flowchart showing an inter-predicted image generating operation.

FIG. 22 is a diagram schematically showing an example structure of a computer device.

FIG. 23 is a diagram schematically showing an example structure of a television apparatus.

FIG. 24 is a diagram schematically showing an example structure of a portable telephone device.

FIG. 25 is a diagram schematically showing an example structure of a recording/reproducing apparatus.

FIG. 26 is a diagram schematically showing an example structure of an imaging apparatus.

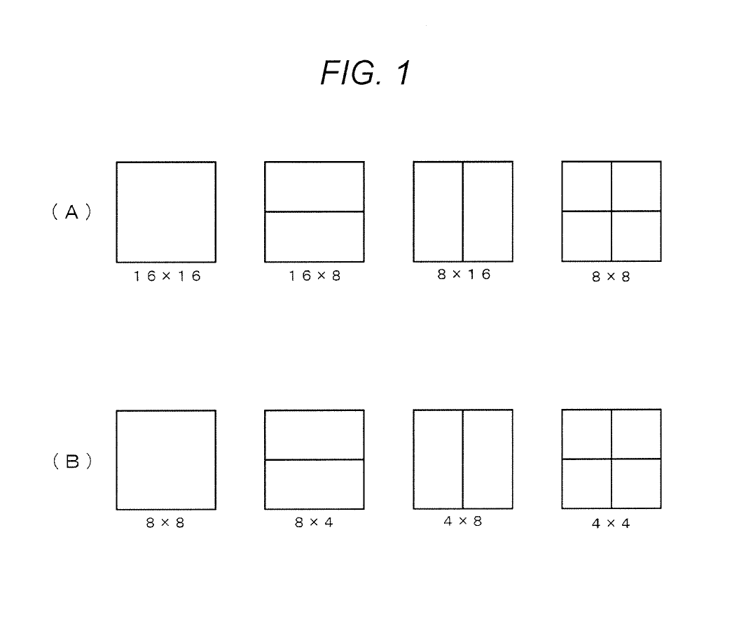

### MODE FOR CARRYING OUT THE INVENTION

The following is a description of embodiments for carrying out the present technique. Explanation will be made in the following order.

1. Structure of an Image Encoding Device

2. Operations of the Image Encoding Device

3. Structure of an Image Decoding Device

4. Operations of the Image Decoding Device

5. Software Processing

6. Applications to Electronic Apparatuses

### [1. Structure of an Image Encoding Device]

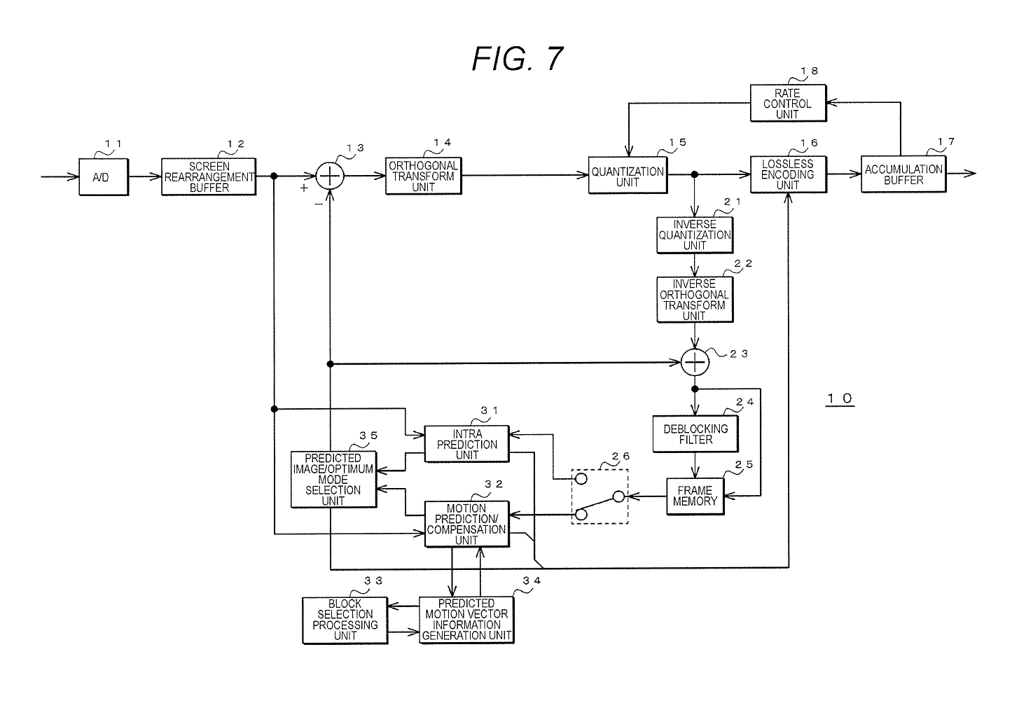

FIG. 7 illustrates the structure of an image processing device that performs image encoding (hereinafter referred to as the “image encoding device”). The image encoding device 10 includes an analog/digital converter (an A/D converter) 11, a screen rearrangement buffer 12, a subtraction unit 13, an orthogonal transform unit 14, a quantization unit 15, a lossless encoding unit 16, an accumulation buffer 17, and a rate control unit 18. The image encoding device 10 further includes an inverse quantization unit 21, an inverse orthogonal transform unit 22, an addition unit 23, a deblocking filter 24, a frame memory 25, an intra prediction unit 31, a motion prediction/compensation unit 32, a block selection processing unit 33, a predicted motion vector information generation unit 34, and a predicted image/optimum mode selection unit 35.

The A/D converter 11 converts analog image signals into digital image data, and outputs the image data to the screen rearrangement buffer 12.

The screen rearrangement buffer 12 rearranges the frames of the image data output from the A/D converter 11. The screen rearrangement buffer 12 rearranges the frames in accordance with the GOP (Group of Pictures) structure related to encoding operations, and outputs the rearranged image data to the subtraction unit 13, the intra prediction unit 31, and the motion prediction/compensation unit 32.

The subtraction unit 13 receives the image data output from the screen rearrangement buffer 12 and predicted image data selected by the later described predicted image/optimum mode selection unit 35. The subtraction unit 13 calculates prediction error data that is the difference between the image data output from the screen rearrangement buffer 12 and the predicted image data supplied from the predicted image/optimum mode selection unit 35, and outputs the prediction error data to the orthogonal transform unit 14.

The orthogonal transform unit 14 performs an orthogonal transform operation, such as a discrete cosine transform (DCT) or a Karhunen-Loeve transform, on the prediction error data output from the subtraction unit 13. The orthogonal transform unit 14 outputs transform coefficient data obtained by performing the orthogonal transform operation to the quantization unit 15.

The quantization unit 15 receives the transform coefficient data output from the orthogonal transform unit 14 and a rate control signal supplied from the later described rate control unit 18. The quantization unit 15 quantizes the transform coefficient data, and outputs the quantized data to the lossless encoding unit 16 and the inverse quantization unit 21. Based on the rate control signal supplied from the rate control unit 18, the quantization unit 15 switches quantization parameters (quantization scales), to change the bit rate of the quantized data.

The lossless encoding unit 16 receives the quantized data output from the quantization unit 15, prediction mode information supplied from the later described intra prediction unit 31, and prediction mode information, difference motion vector information, and the like supplied from the motion prediction/compensation unit 32. Also, information indicating whether an optimum mode is an intra prediction or an inter prediction is supplied from the predicted image/optimum mode selection unit 35. The prediction mode information contains information indicating a prediction mode, block size information about motion compensation blocks, and the like, in accordance with whether the prediction mode is an intra prediction or an inter prediction. The lossless encoding unit 16 performs a lossless encoding operation on the quantized data through variable-length coding or arithmetic coding or the like, to generate and output compressed image information to the accumulation buffer 17. When the optimum mode is an intra prediction, the lossless encoding unit 16 performs lossless encoding on the prediction mode information supplied from the intra prediction unit 31. When the optimum mode is an inter prediction, the lossless encoding unit 16 performs lossless encoding on the prediction mode information, the difference motion vector information, and the like supplied from the motion prediction/compensation unit 32. Further, the lossless encoding unit 16 incorporates the information subjected to the lossless encoding into the compressed image information. For example, the lossless encoding unit 16 adds the information to the header information in an encoded stream that is the compressed image information.

The accumulation buffer 17 stores the compressed image information supplied from the lossless encoding unit 16. The accumulation buffer 17 also outputs the stored compressed image information at a transmission rate in accordance with the transmission path.

The rate control unit 18 monitors the free space in the accumulation buffer 17, generates a rate control signal in accordance with the free space, and outputs the rate control signal to the quantization unit 15. The rate control unit 18 obtains information indicating the free space from the accumulation buffer 17, for example. When the remaining free space is small, the rate control unit 18 lowers the bit rate of the quantized data through the rate control signal. When the remaining free space in the accumulation buffer 17 is sufficiently large, the rate control unit 18 increases the bit rate of the quantized data through the rate control signal.

The inverse quantization unit 21 inversely quantizes the quantized data supplied from the quantization unit 15. The inverse quantization unit 21 outputs the transform coefficient data obtained by performing the inverse quantization operation to the inverse orthogonal transform unit 22.

The inverse orthogonal transform unit 22 performs an inverse orthogonal transform operation on the transform coefficient data supplied from the inverse quantization unit 21, and outputs the resultant data to the addition unit 23.

The addition unit 23 adds the data supplied from the inverse orthogonal transform unit 22 to the predicted image data supplied from predicted image/optimum mode selection unit 35, to generate decoded image data. The addition unit 23 then outputs the decoded image data to the deblocking filter 24 and the frame memory 25. The decoded image data is used as the image data of a reference image.

The deblocking filter 24 performs a filtering operation to reduce block distortions that occur at the time of image encoding. The deblocking filter 24 performs a filtering operation to remove block distortions from the decoded image data supplied from the addition unit 23, and outputs the filtered decoded image data to the frame memory 25.

The frame memory 25 stores the decoded image data that has not been subjected to the filtering operation and been supplied from the addition unit 23, and the decoded image data that has been subjected to the filtering operation and been supplied from the deblocking filter 24. The decoded image data stored in the frame memory 25 is supplied as reference image data to the intra prediction unit 31 or the motion prediction/compensation unit 32 via a selector 26.

When an intra prediction is performed at the intra prediction unit 31, the selector 26 supplies the decoded image data that has not been subjected to the deblocking filtering operation and is stored in the frame memory 25, as reference image data, to the intra prediction unit 31. When an inter prediction is performed at the motion prediction/compensation unit 32, the selector 26 supplies the decoded image data that has been subjected to the deblocking filtering operation and is stored in the frame memory 25, as reference image data, to the motion prediction/compensation unit 32.

Using the input image data of an encoding target image supplied from the screen rearrangement buffer 12 and the reference image data supplied from the frame memory 25, the intra prediction unit 31 performs predictions in all candidate intra prediction modes, to determine an optimum intra prediction mode. The intra prediction unit 31 calculates a cost function value in each of the intra prediction modes, for example, and sets the optimum intra prediction mode that is the intra prediction mode with the highest encoding efficiency, based on the calculated cost function values. The intra prediction unit 31 outputs the predicted image data generated in the optimum intra prediction mode and the cost function value in the optimum intra prediction mode to the predicted image/optimum mode selection unit 35. The intra prediction unit 31 further outputs prediction mode information indicating the optimum intra prediction mode to the lossless encoding unit 16.

Using the input image data of the encoding target image supplied from the screen rearrangement buffer 12 and the reference image data supplied from the frame memory 25, the motion prediction/compensation unit 32 performs predictions in all candidate inter prediction modes, to determine an optimum inter prediction mode. The motion prediction/compensation unit 32 calculates a cost function value in each of the inter prediction modes, for example, and sets the optimum inter prediction mode that is the inter prediction mode with the highest encoding efficiency, based on the calculated cost function values. The motion prediction/compensation unit 32 outputs the predicted image data generated in the optimum inter prediction mode and the cost function value in the optimum inter prediction mode to the predicted image/optimum mode selection unit 35. The motion prediction/compensation unit 32 further outputs prediction mode information about the optimum inter prediction mode to the lossless encoding unit 16. The motion prediction/compensation unit 32 also generates difference motion vector information using predicted motion vector information generated by the predicted motion vector information generation unit 34, and determines the inter prediction mode that has the highest encoding efficiency when the difference motion vector information is used.

The block selection processing unit 33 selects a block from adjacent motion compensation blocks, in accordance with the block size of the motion compensation block being encoded and the block sizes of the encoded adjacent motion compensation blocks adjacent to this motion compensation block. The block selection processing unit 33 selects only the adjacent motion compensation block that has been encoded in a size of the same hierarchical level as the motion compensation block being encoded, and outputs the block selection result to the predicted motion vector information generation unit 34.

The predicted motion vector information generation unit 34 generates the predicted motion vector information to be used in encoding the motion vector information about the motion compensation block being encoded, using the motion vector information about the block selected by the block selection processing unit 33. The predicted motion vector information generation unit 34 also outputs the generated predicted motion vector information to the motion prediction/compensation unit 32.

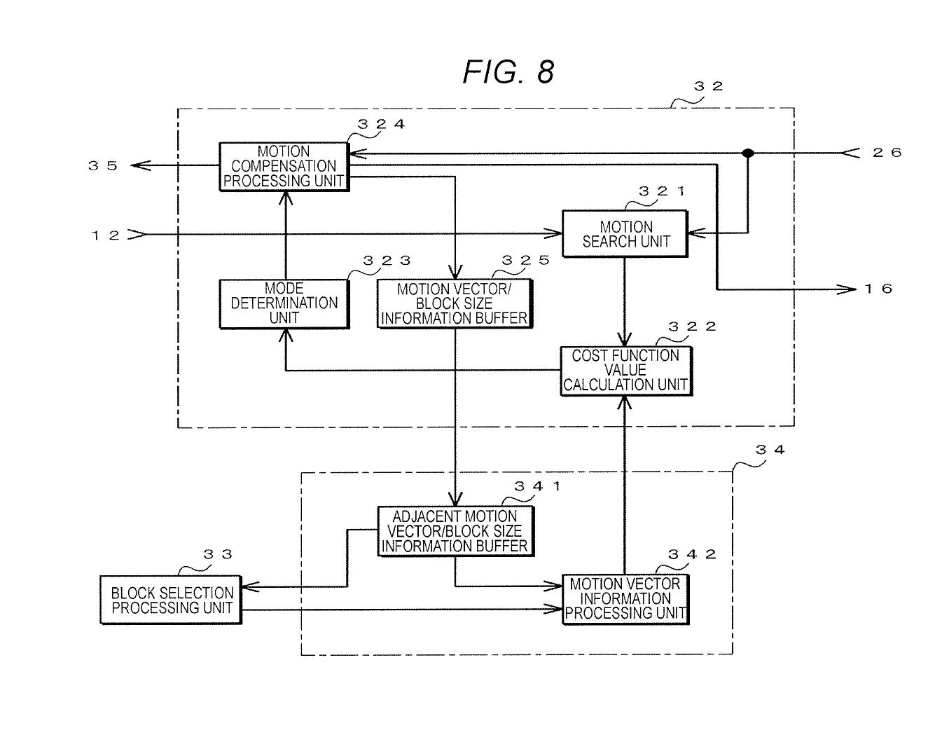

FIG. 8 illustrates the structures of the motion prediction/compensation unit 32 and the predicted motion vector information generation unit 34. The motion prediction/compensation unit 32 includes a motion search unit 321, a cost function value calculation unit 322, a mode determination unit 323, a motion compensation processing unit 324, and a motion vector/block size information buffer 325.

Rearranged input image data supplied from the screen rearrangement buffer 12, and reference image data read from the frame memory 25 are supplied to the motion search unit 321. The motion search unit 321 conducts motion searches in all the candidate inter prediction modes, to detect motion vectors. The motion search unit 321 outputs the motion vector information indicating the detected motion vectors, together with the input image data and reference image data for a case where motion vectors have been detected, to the cost function value calculation unit 322.

To the cost function value calculation unit 322, the motion vector information, the input image data, and the reference image data are supplied from the motion search unit 321, and the predicted motion vector information is supplied from the predicted motion vector information generation unit 34. Using the motion vector information, the input image data, the reference image data, and the predicted motion vector information, the cost function value calculation unit 322 calculates cost function values in all the candidate inter prediction modes.

As specified in the JM (Joint Model), which is the reference software in H.264/AVC, the cost function values are calculated by the technique of High Complexity Mode or Low Complexity Mode.

Specifically, in the High Complexity Mode, the operation that ends with the lossless encoding operation is provisionally performed in each candidate prediction mode, to calculate the cost function value expressed by the following equation (9) in each prediction mode:

Cost(ModeεΩ)=D+λ·R (9)

Here, Ω represents the universal set of the candidate prediction modes for encoding the image of the motion compensation block. D represents the energy difference (distortion) between the decoded image and the input image in a case where encoding is performed in a prediction mode. R represents the bit generation rate including orthogonal transform coefficients and prediction mode information, and λ represents the Lagrange multiplier given as the function of a quantization parameter QP.

That is, to perform encoding in the High Complexity Mode, a provisional encoding operation needs to be performed in all the candidate prediction modes to calculate the above parameters D and R, and therefore, a larger amount of calculation is required.

In the Low Complexity Mode, on the other hand, predicted images, header bits containing difference motion vector information and prediction mode information, and the like are generated in all the candidate prediction modes, to calculate cost function values expressed by the following equation (10):

Cost(ModeεΩ)=D+QP2Quant(QP)·Header_Bit (10)

Here, Ω represents the universal set of the candidate prediction modes for encoding the image of the motion compensation block. D represents the energy difference (distortion) between the decoded image and the input image in a case where encoding is performed in a prediction mode. Header_Bit represents the header bit corresponding to the prediction mode, and QP2Quant is the function given as the function of the quantization parameter QP.

That is, in the Low Complexity Mode, a prediction operation needs to be performed in each prediction mode, but any decoded image is not required. Accordingly, the amount of calculation can be smaller than that required in the High Complexity Mode.

The cost function value calculation unit 322 calculates the cost function values, taking into account the difference motion vector information indicating the differences between the motion vectors indicated by the motion vector information supplied from the motion search unit 321 and the predicted motion vectors indicated by the predicted motion vector information, as described above. The cost function value calculation unit 322 outputs the calculated cost function values to the mode determination unit 323.

The mode determination unit 323 determines the mode with the smallest cost function value to be the optimum inter prediction mode. The mode determination unit 323 also outputs the prediction mode information indicating the determined optimum inter prediction mode, as well as the motion vector information and the difference motion vector information and the like related to the optimum inter prediction mode, to the motion compensation processing unit 324. Here, the prediction mode information contains the block size information about motion compensation blocks, and the like.

Based on the optimum inter prediction mode information and the motion vector information, the motion compensation processing unit 324 performs motion compensation on the reference image data read from the frame memory 25, generates predicted image data, and outputs the predicted image data to the predicted image/optimum mode selection unit 35. The motion compensation processing unit 324 also outputs the prediction mode information about the optimum inter prediction, the difference motion vector information in the mode, and the like, to the lossless encoding unit 16.

The motion vector/block size information buffer 325 stores the motion vector information about the optimum inter prediction mode and the block size information about the motion compensation blocks. The motion vector/block size information buffer 325 also outputs the motion vector information about encoded motion compensation blocks adjacent to the motion compensation block being encoded (hereinafter referred to as the “adjacent motion vector information”) and the corresponding block size information (hereinafter referred to the “adjacent block size information”) to the predicted motion vector information generation unit 34.

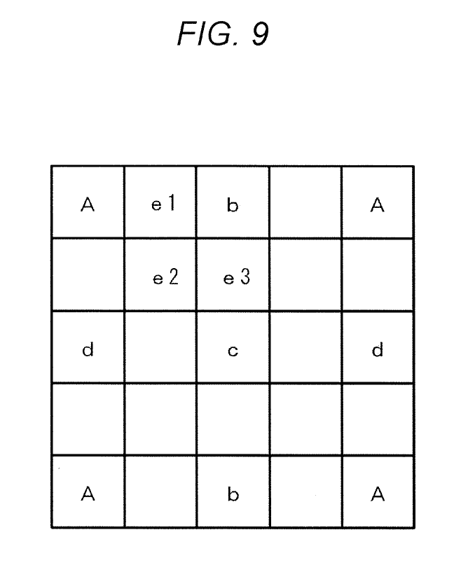

The motion prediction/compensation unit 32 performs a motion prediction/compensation operation with ¼ pixel precision, which is specified in H.264/AVC, for example. FIG. 9 is a diagram for explaining a motion prediction/compensation operation with ¼ pixel precision. In FIG. 9, position “A” represents the location of each integer precision pixel stored in the frame memory 25, positions “b”, “c”, and “d” represent the locations of ½ pixel precision pixels, positions “e1”, “e2”, and “e3” represent the locations of ¼ pixel precision pixels.

In the following, Clip1( ) is defined as shown in the equation (11).

$$\begin{matrix}[ Mathematical Formula 1 ] & \\ Clip 1 ( a ) = \{ \begin{matrix}0 ; if ( a < 0 ) \\ a ; otherwise \\ max\_pix ; if ( a > max\_pix )\end{matrix} & ( 11 )\end{matrix}$$

In the equation (11), the value of max_pix is 255 when an input image has 8-bit precision.

The pixel values in the positions “b” and “d” are generated by using a 6-tap FIR filter as shown in the equations (12) and (13).

F=A₋₂−5·A₋₁+20·A₀+20·A₁−5·A₂+A₃ (12)

b,d=Clip1((F+16)>>5) (13)

The pixel value in the position “c” is generated by using a 6-tap FIR filter as shown in the equation (14) or (15) and the equation (16).

F=b₋₂−5·b₋₁+20·b₀+20·b₁−5·b₂+b₃ (14)

F=d₋₂−5·d₋₁+20·d₀+20·d₁−5·d₂+d₃ (15)

c=Clip1((F+512)>>10) (16)

The Clip1 processing is performed only once at last after product-sum operations are performed both in the horizontal direction and the vertical direction.

The pixel values in the positions “e1” through “e3” are generated by linear interpolations as shown in the equations (17) through (19).

e1=(A+b+1)>>1 (17)

e2=(b+d+1)>>1 (18)

e3=(b+c+1)>>1 (19)

In this manner, the motion prediction/compensation unit 32 performs a motion prediction/compensation operation with ¼ pixel precision.

The predicted motion vector information generation unit 34 includes an adjacent motion vector/block size information buffer 341 and a motion vector information processing unit 342.

The adjacent motion vector/block size information buffer 341 stores the adjacent motion vector information and the adjacent block size information supplied from the motion vector/block size information buffer 325 of the motion prediction/compensation unit 32. The adjacent motion vector/block size information buffer 341 also outputs the stored adjacent block size information to the block selection processing unit 33. The adjacent motion vector/block size information buffer 341 also outputs the stored adjacent motion vector information to the motion vector information processing unit 342.

Based on the motion vector information about adjacent motion compensation blocks indicated in the block selection result supplied from the block selection processing unit 33, the motion vector information processing unit 342 generates predicted motion vector information. The motion vector information processing unit 342 outputs the generated predicted motion vector information to the cost function value calculation unit 322 of the motion prediction/compensation unit 32. It should be noted that, based on the adjacent block size information supplied from the adjacent motion vector/block size information buffer 341, the block selection processing unit 33 selects only the encoded adjacent motion compensation block having a size of the same hierarchical level as the motion compensation block being encoded. The block selection processing unit 33 outputs the block selection result indicating the selected adjacent motion compensation block to the motion vector information processing unit 342 of the predicted motion vector information generation unit 34.

Referring back to FIG. 7, the predicted image/optimum mode selection unit 35 compares the cost function value supplied from the intra prediction unit 31 with the cost function value supplied from the motion prediction/compensation unit 32, and selects the smaller cost function value as the optimum mode with the highest encoding efficiency. The predicted image/optimum mode selection unit 35 also outputs the predicted image data generated in the optimum mode to the subtraction unit 13 and the addition unit 23. Further, the predicted image/optimum mode selection unit 35 outputs information indicating whether the optimum mode is an intra prediction mode or an inter prediction mode, to the lossless encoding unit 16. The predicted image/optimum mode selection unit 35 switches to an intra prediction or to an inter prediction for each slice.

### [2. Operations of the Image Encoding Device]

In the image encoding device, macroblock sizes are made larger than those in H.264/AVC, and encoding operations are performed.

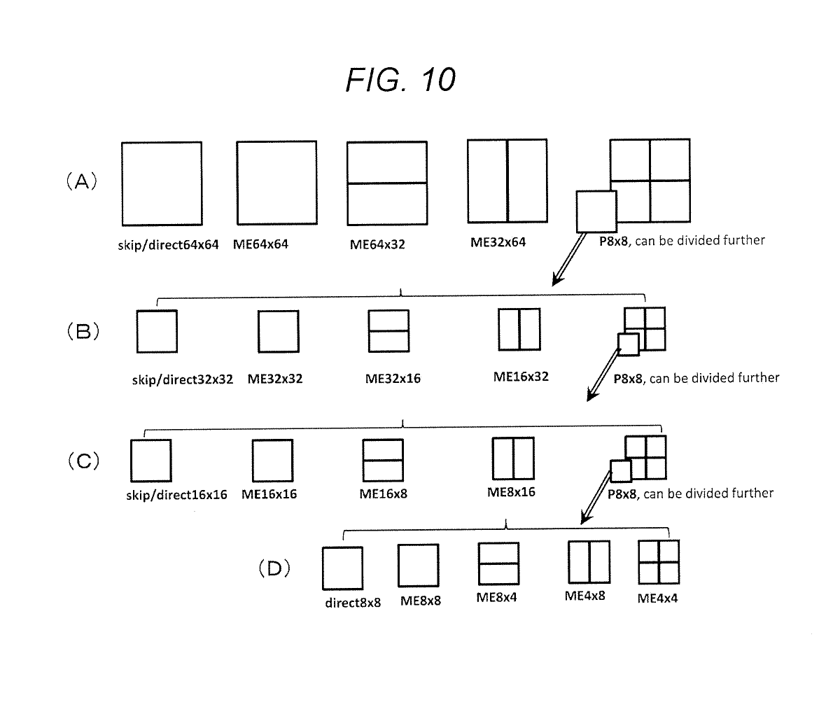

FIG. 10 illustrate a hierarchical structure where macroblock sizes are extended. Of FIG. 10, FIGS. 10(C) and 10(D) show a 16×16 pixel macroblock and an 8×8 pixel sub-macroblock defined in H.264/AVC. As macroblocks with larger sizes than those in H.264/AVC, a 64×64 pixel macroblock shown in FIG. 10(A) and a 32×32 pixel macroblock shown in FIG. 10(B) are specified. It should be noted that, in FIG. 10, each “skip/direct” indicates a block size used in a case where a skipped macroblock mode or a direct mode is selected. Also, each “ME” indicates a motion compensation block size. Each “P8×8” indicates that the block can be further divided on a lower hierarchical level with a smaller block size.

On one hierarchical level, block sizes of motion compensation blocks including sizes of divided macroblocks are set. For example, on the hierarchical level of the 64×64 pixel macroblock shown in FIG. 10(A), 64×64 pixels, 64×32 pixels, 32×64 pixels, and 32×32 pixels are set as the block sizes of the motion compensation blocks belonging to the same hierarchical level.

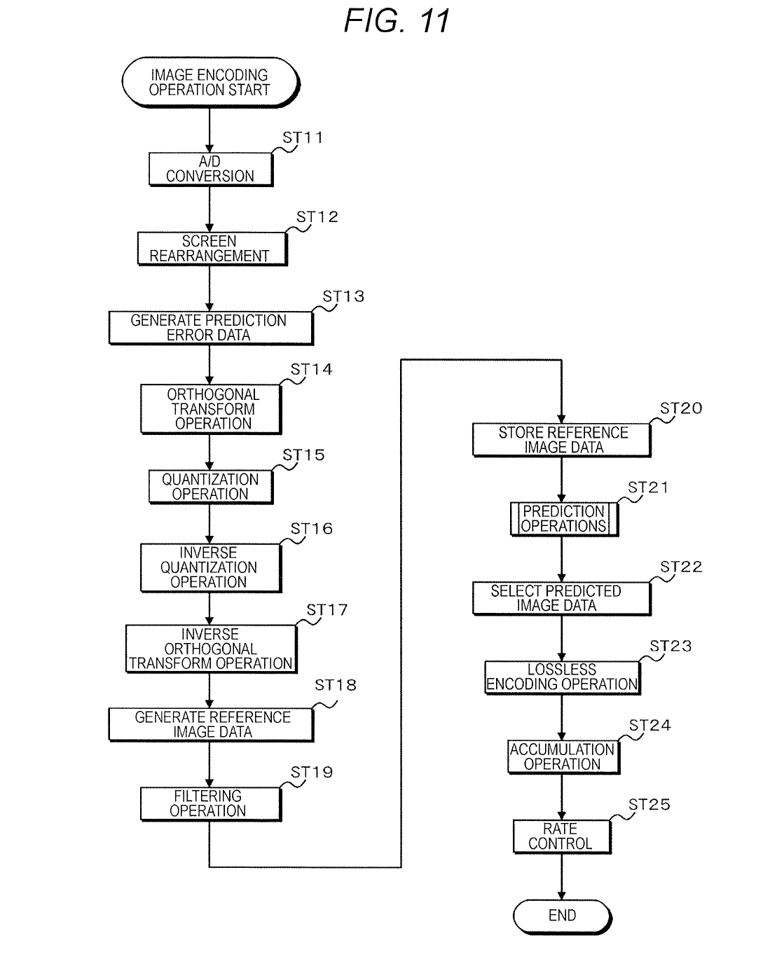

FIG. 11 is a flowchart showing an operation of the image encoding device. In step ST11, the A/D converter 11 performs an A/D conversion on an input image signal.

In step ST12, the screen rearrangement buffer 12 performs image rearrangement. The screen rearrangement buffer 12 stores the image data supplied from the A/D converter 11, and rearranges the respective pictures in encoding order, instead of display order.

In step ST13, the subtraction unit 13 generates prediction error data. The subtraction unit 13 generates the prediction error data by calculating the differences between the image data of the images rearranged in step ST12 and predicted image data selected by the predicted image/optimum mode selection unit 35. The prediction error data has a smaller data amount than the original image data. Accordingly, the data amount can be made smaller than in a case where images are directly encoded.

In step ST14, the orthogonal transform unit 14 performs an orthogonal transform operation. The orthogonal transform unit 14 orthogonally transforms the prediction error data supplied from the subtraction unit 13. Specifically, orthogonal transforms such as discrete cosine transforms or Karhunen-Loeve transforms are performed on the prediction error data, and transform coefficient data is output.

In step ST15, the quantization unit 15 performs a quantization operation. The quantization unit 15 quantizes the transform coefficient data. In the quantization, rate control is performed as will be described later in the description of step ST25.

In step ST16, the inverse quantization unit 21 performs an inverse quantization operation. The inverse quantization unit 21 inversely quantizes the transform coefficient data quantized at the quantization unit 15, having characteristics compatible with the characteristics of the quantization unit 15.

In step ST17, the inverse orthogonal transform unit 22 performs an inverse orthogonal transform operation. The inverse orthogonal transform unit 22 performs an inverse orthogonal transform on the transform coefficient data inversely quantized at the inverse quantization unit 21, having the characteristics compatible with the characteristics of the orthogonal transform unit 14.

In step ST18, the addition unit 23 generates reference image data. The addition unit 23 generates the reference image data (decoded image data) by adding the predicted image data supplied from the predicted image/optimum mode selection unit 35 to the data of the location that corresponds to the predicted image and has been subjected to the inverse orthogonal transform.

In step ST19, the deblocking filter 24 performs a filtering operation. The deblocking filter 24 removes block distortions by filtering the decoded image data output from the addition unit 23.

In step ST20, the frame memory 25 stores the reference image data. The frame memory 25 stores the filtered reference image data (the decoded image data).

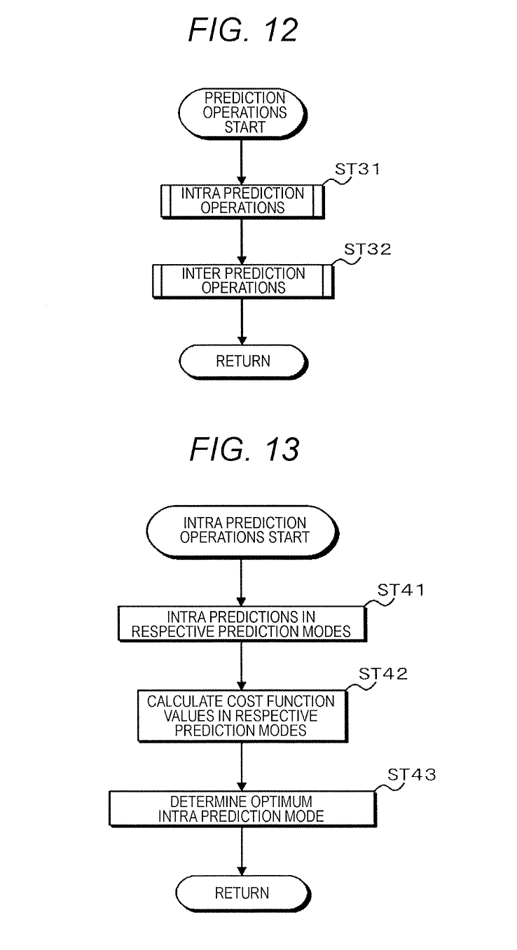

In step ST21, the intra prediction unit 31 and the motion prediction/compensation unit 32 each perform prediction operations. Specifically, the intra prediction unit 31 performs intra prediction operations in intra prediction modes, and the motion prediction/compensation unit 32 performs motion prediction/compensation operations in inter prediction modes. The prediction operations will be described later in detail with reference to FIG. 12. In this step, prediction operations are performed in all candidate prediction modes, and cost function values are calculated in all the candidate prediction modes. Based on the calculated cost function values, an optimum intra prediction mode and an optimum inter prediction mode are selected, and the predicted images generated in the selected prediction modes, the cost functions, and the prediction mode information are supplied to the predicted image/optimum mode selection unit 35.

In step ST22, the predicted image/optimum mode selection unit 35 selects predicted image data. Based on the respective cost function values output from the intra prediction unit 31 and the motion prediction/compensation unit 32, the predicted image/optimum mode selection unit 35 determines the optimum mode to optimize the encoding efficiency. The predicted image/optimum mode selection unit 35 further selects the predicted image data in the determined optimum mode, and outputs the selected predicted image data to the subtraction unit 13 and the addition unit 23. This predicted image data is used in the operations in steps ST13 and ST18, as described above.

In step ST23, the lossless encoding unit 16 performs a lossless encoding operation. The lossless encoding unit 16 performs lossless encoding on the quantized data output from the quantization unit 15. That is, lossless encoding such as variable-length coding or arithmetic coding is performed on the quantized data, to compress the data. The lossless encoding unit 16 also performs lossless encoding on the prediction mode information and the like corresponding to the predicted image data selected in step ST22, so that lossless-encoded data of the prediction mode information and the like is incorporated into the compressed image information generated by performing lossless encoding on the quantized data.

In step ST24, the accumulation buffer 17 performs an accumulation operation. The accumulation buffer 17 stores the compressed image information output from the lossless encoding unit 16. The compressed image information stored in the accumulation buffer 17 is read and transmitted to the decoding side via a transmission path where necessary.

In step ST25, the rate control unit 18 performs rate control. The rate control unit 18 controls the quantization operation rate of the quantization unit 15 so that an overflow or an underflow does not occur in the accumulation buffer 17 when the accumulation buffer 17 stores compressed image information.

Referring now to the flowchart in FIG. 12, the prediction operations in step ST21 of FIG. 11 are described.

In step ST31, the intra prediction unit 31 performs intra prediction operations. The intra prediction unit 31 performs intra predictions on the image of the motion compensation block being encoded in all the candidate intra prediction modes. The image data of a decoded image to be referred to in each intra prediction is decoded image data yet to be subjected to a blocking filtering operation at the deblocking filter 24. In the intra prediction operations, intra predictions are performed in all the candidate intra prediction modes, and cost function values are calculated in all the candidate intra prediction modes. Based on the calculated cost function values, the intra prediction mode with the highest encoding efficiency is selected from all the intra prediction modes.

In step ST32, the motion prediction/compensation unit 32 performs inter prediction operations. Using the decoded image data that is stored in the frame memory 25 and has been subjected to the deblocking filtering operation, the motion prediction/compensation unit 32 performs inter prediction operations in the candidate inter prediction modes. In the inter prediction operations, inter prediction operations are performed in all the candidate inter prediction modes, and cost function values are calculated in all the candidate inter prediction modes. Based on the calculated cost function values, the inter prediction mode with the highest encoding efficiency is selected from all the inter prediction modes.

Referring now to the flowchart in FIG. 13, the intra prediction operations in step ST31 of FIG. 12 are described.

In step ST41, the intra prediction unit 31 performs intra prediction operations in the respective prediction modes. Using the decoded image data yet to be subjected to the blocking filtering operation, the intra prediction unit 31 generates predicted image data in each intra prediction mode.

In step ST42, the intra prediction unit 31 calculates the cost function value in each prediction mode. As specified in the JM (Joint Model), which is the reference software in H.264/AVC, the cost function values are calculated by the technique of High Complexity Mode or Low Complexity Mode as described above. Specifically, in the High Complexity Mode, the operation that ends with the lossless encoding operation is provisionally performed as the operation of step ST42 in all the candidate prediction modes, to calculate the cost function value expressed by the equation (9) in each prediction mode. In the Low Complexity Mode, the generation of a predicted image and the calculation of the header bit such as motion vector information and prediction mode information are performed as the operation of step ST42 in all the candidate prediction modes, and the cost function value expressed by the equation (10) is calculated in each prediction mode.

In step ST43, the intra prediction unit 31 determines the optimum intra prediction mode. Based on the cost function values calculated in step ST42, the intra prediction unit 31 selects the one intra prediction mode with the smallest cost function value among the calculated cost function values, and determines the selected intra prediction mode to be the optimum intra prediction mode.

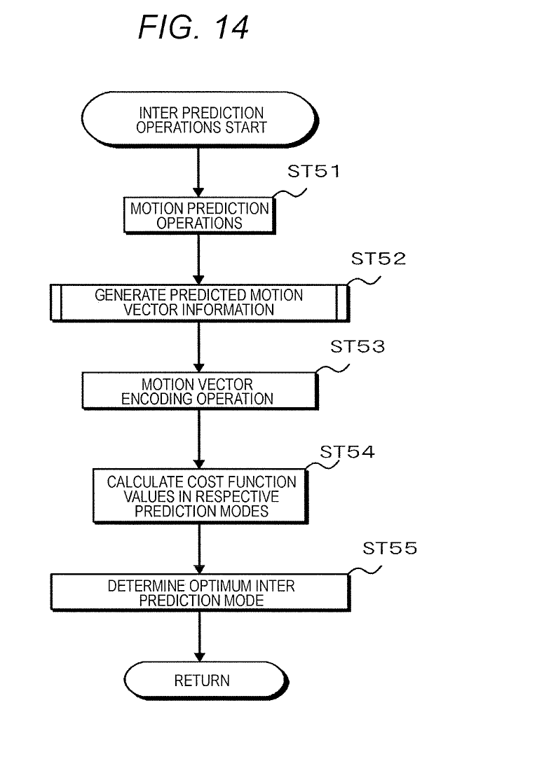

Referring now to the flowchart in FIG. 14, the inter prediction operations in step ST32 of FIG. 12 are described.

In step ST51, the motion prediction/compensation unit 32 performs motion prediction operations. The motion prediction/compensation unit 32 performs a motion prediction in each prediction mode, to detect motion vectors. The operation then moves on to step ST52.

In step ST52, the predicted motion vector information generation unit 34 generates predicted motion vector information. Using the motion vector information about an encoded adjacent motion compensation block having a block size of the same hierarchical level as the motion compensation block being encoded, the predicted motion vector information generation unit 34 generates the predicted motion vector information. For example, the motion compensation block being encoded has one of the block sizes (64×64 pixels, 32×64 pixels, 32×64 pixels, and 32×32 pixels) of the hierarchical level shown in FIG. 10(A). In this case, the predicted motion vector information is generated by using the motion vector information about an adjacent motion compensation block having a block size of the same hierarchical level.

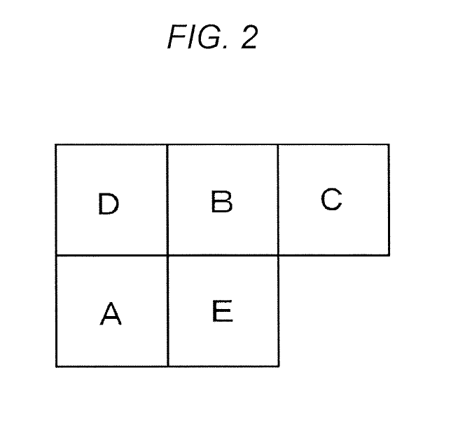

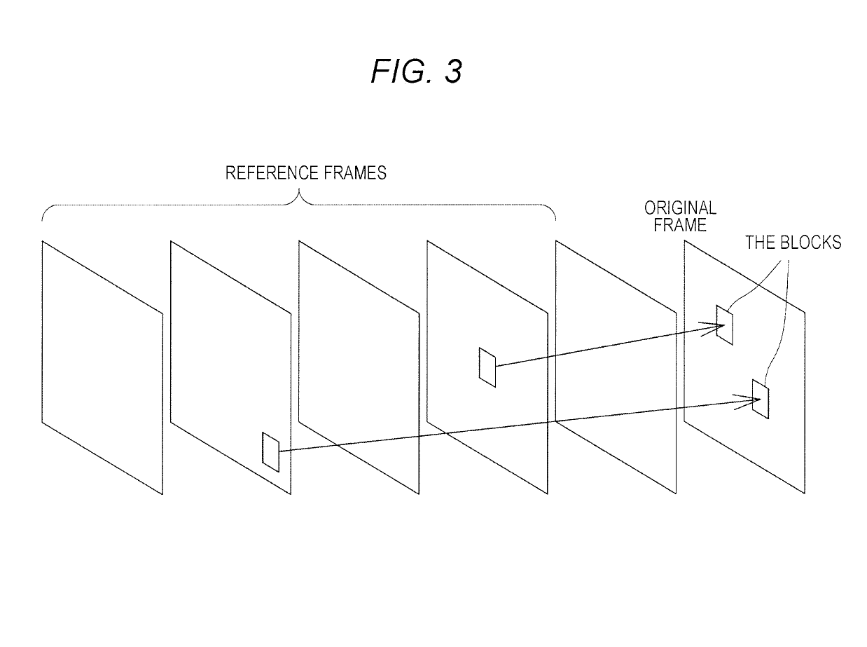

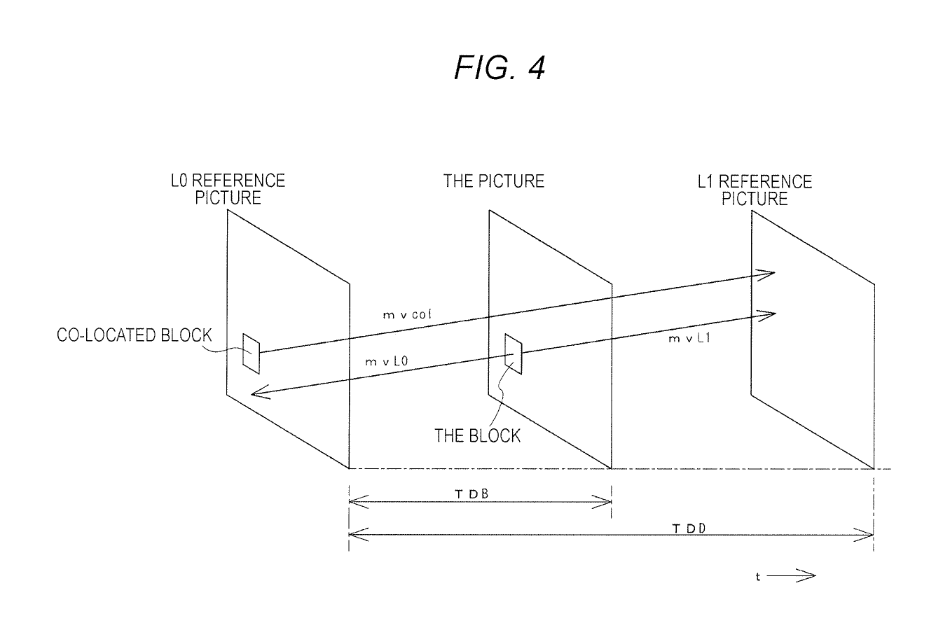

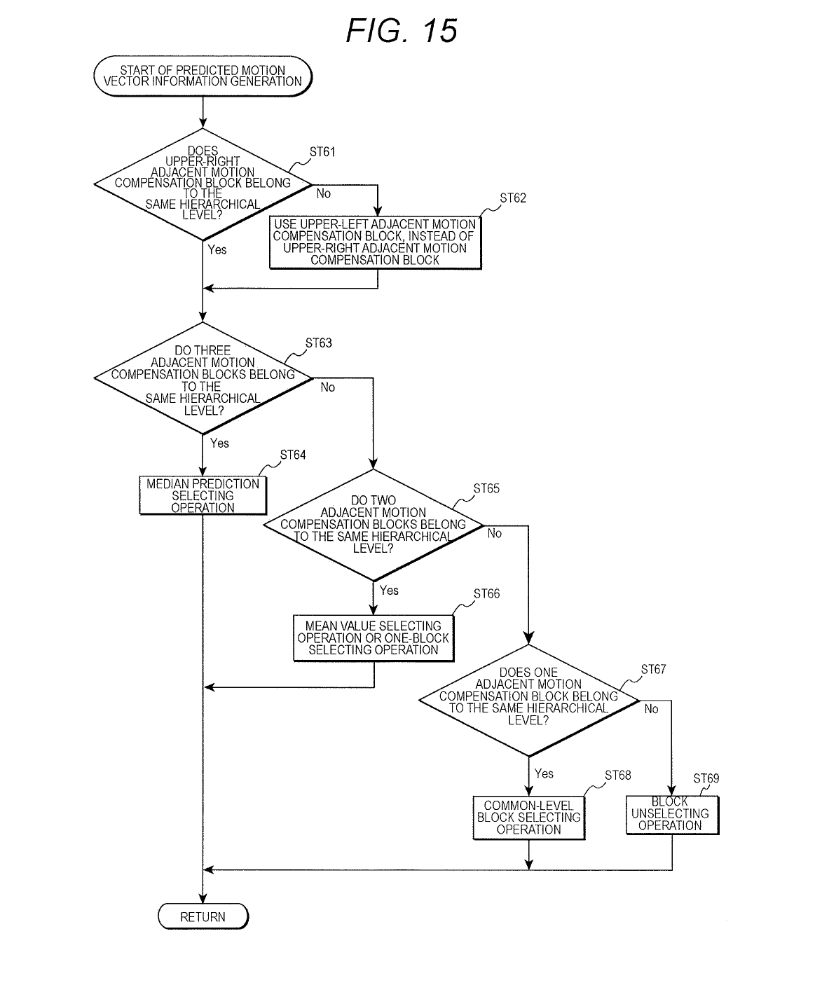

FIG. 15 is a flowchart showing a predicted motion vector information generating operation. In step ST61, the block selection processing unit 33 determines whether the upper-right adjacent motion compensation block is of the same hierarchical level. The block selection processing unit 33 determines whether the adjacent motion compensation block located in an upper right position with respect to the motion compensation block being encoded has a block size of the same hierarchical level as the motion compensation block being encoded. Where the upper-right adjacent motion compensation block or the motion compensation block being encoded is the block E in FIG. 2, the block selection processing unit 33 determines whether the adjacent motion compensation block C has a block size of the same hierarchical level as the block E. When having determined that the upper-right adjacent motion compensation block does not have a block size of the same hierarchical level, the block selection processing unit 33 moves on to step ST62. When having determined that the upper-right adjacent motion compensation block has a block size of the same hierarchical level, the block selection processing unit 33 moves on to step ST63.

In step ST62, the block selection processing unit 33 uses the upper-left adjacent motion compensation block, instead of the upper-right adjacent motion compensation block, and moves on to step ST63. By performing such an operation, the block selection processing unit 33 prevents a decrease in the adjacent motion compensation blocks to be used in generating predicted motion vector information, when the motion compensation block is located at a corner of the frame and there is no upper-right adjacent motion compensation block.

In step ST63, the block selection processing unit 33 determines whether there are three adjacent motion compensation blocks belonging to the same hierarchical level. When the three adjacent motion compensation blocks located in the left, upper, and upper right (or upper left) positions with respect to the motion compensation block being encoded have block sizes of the same hierarchical level as the motion compensation block being encoded, the block selection processing unit 33 moves on to step ST64. When at least one of the three adjacent motion compensation blocks has a block size of a different hierarchical level, the block selection processing unit 33 moves on to step ST65. When the size of the block E in FIG. 2 is the block size of 64×32 pixels of the hierarchical level shown in FIG. 10(A), and the blocks A, B, and C (or D) have block sizes of the hierarchical level shown in FIG. 10(A), for example, the block selection processing unit 33 moves on to step ST64. Also, when at least one of the blocks A, B, and C (or D) does not have a block size of the hierarchical level shown in FIG. 10(A), the block selection processing unit 33 moves on to step ST65.

In step ST64, the block selection processing unit 33 performs a median prediction selecting operation. The block selection processing unit 33 outputs a block selection result indicating a selection of three adjacent motion compensation blocks to the predicted motion vector information generation unit 34, and causes the predicted motion vector information generation unit 34 to perform a median prediction. When the block selection result indicates three adjacent motion compensation blocks, the motion vector information processing unit 342 of the predicted motion vector information generation unit 34 performs a median prediction by using the motion vector information about the three adjacent motion compensation blocks indicated by the block selection result.

In step ST65, the block selection processing unit 33 determines whether there are two adjacent motion compensation blocks belonging to the same hierarchical level. When two of the adjacent motion compensation blocks located in the left, upper, and upper right (or upper left) positions with respect to the motion compensation block being encoded have block sizes of the same hierarchical level as the motion compensation block being encoded, the block selection processing unit 33 moves on to step ST66. When two or three adjacent motion compensation blocks do not have block sizes of the same hierarchical level as the motion compensation block being encoded, the block selection processing unit 33 moves on to step ST67.

In step ST66, the block selection processing unit 33 performs a mean value selecting operation or a one-block selecting operation. When performing a mean value selecting operation, the block selection processing unit 33 outputs a block selection result indicating a selection of two adjacent motion compensation blocks belonging to the same hierarchical level, to the predicted motion vector information generation unit 34. When the block selection result indicates two adjacent motion compensation blocks, the motion vector information processing unit 342 of the predicted motion vector information generation unit 34 calculates the mean value among the motion vectors indicated by the motion vector information about the two adjacent motion compensation blocks. The motion vector information processing unit 342 also sets the motion vector information indicating the calculated mean value as predicted motion vector information. When performing a one-block selecting operation, the block selection processing unit 33 outputs a block selection result indicating one of two adjacent motion compensation blocks belonging to the same hierarchical level, to the predicted motion vector information generation unit 34. When the block selection result indicates one adjacent motion compensation block, the motion vector information processing unit 342 of the predicted motion vector information generation unit 34 sets predicted motion vector information that is the motion vector information about the adjacent motion compensation block indicated by the block selection result.

In step ST67, the block selection processing unit 33 determines whether there is one adjacent motion compensation block belonging to the same hierarchical level. When only one of the adjacent motion compensation blocks located in the left, upper, and upper right (or upper left) positions with respect to the motion compensation block being encoded has a block size of the same hierarchical level as the motion compensation block being encoded, the block selection processing unit 33 moves on to step ST68. When the three adjacent motion compensation blocks do not have block sizes of the same hierarchical level as the motion compensation block being encoded, the block selection processing unit 33 moves on to step ST69.

In step ST68, the block selection processing unit 33 performs a common-level block selecting operation. The block selection processing unit 33 outputs a block selection result indicating a selection of one adjacent motion compensation block belonging to the same hierarchical level to the predicted motion vector information generation unit 34. When the block selection result indicates one adjacent motion compensation block, the motion vector information processing unit 342 of the predicted motion vector information generation unit 34 sets predicted motion vector information that is the motion vector information about the adjacent motion compensation block indicated by the block selection result.

In step ST69, the block selection processing unit 33 performs a block unselecting operation. The block selection processing unit 33 outputs a block selection result indicating that there are no adjacent motion compensation blocks belonging to the same hierarchical level, to the predicted motion vector information generation unit 34. When the block selection result indicates that there are no adjacent motion compensation blocks, the motion vector information processing unit 342 of the predicted motion vector information generation unit 34 generates predicted motion vector information indicating a zero-vector.

As described above, the block selection processing unit 33 selects one or more adjacent motion compensation blocks, in accordance with the block sizes of the motion compensation block being encoded and the adjacent motion compensation blocks. The predicted motion vector information generation unit 34 also generates predicted motion vector information by using the motion vector information about the selected adjacent motion compensation block(s), and outputs the predicted motion vector information to the motion prediction/compensation unit 32.

The predicted motion vector information generation unit 34 also outputs predicted motion vector information that is the mean motion vector value indicated by the motion vector information about two adjacent motion compensation blocks or identification information for identifying which one of the two adjacent motion compensation blocks is selected. The mean motion vector value or the identification information is contained in compressed image information.

The predicted motion vector information generating operation shown in FIG. 15 is to generate predicted motion vector information by using spatially adjacent motion compensation blocks. If the predicted motion vector information is generated by further using temporally adjacent motion compensation blocks, the generated predicted motion vector information can further increase the encoding efficiency.

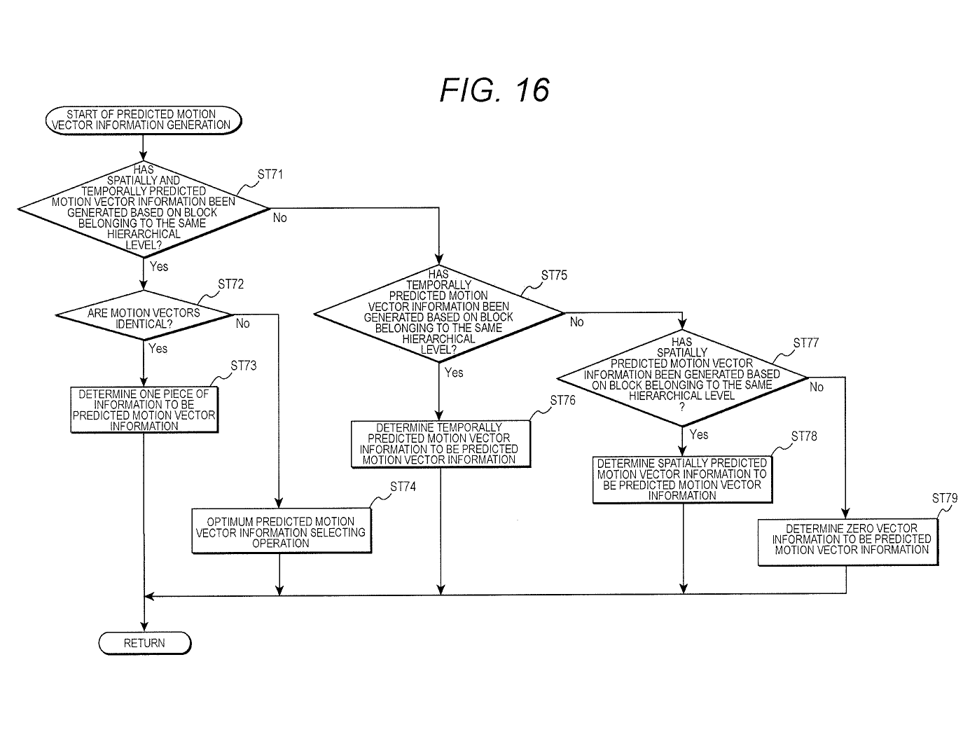

FIG. 16 shows a predicted motion vector information generating operation using spatially and temporally adjacent motion compensation blocks.

In step ST71, the predicted motion vector information generation unit 34 determines whether spatially and temporally predicted motion vector information has been generated based on a block belonging to the same hierarchical level as the motion compensation block being encoded. When predicted motion vector information has been generated based on the motion vector information about a spatially adjacent motion compensation block having a block size of the same hierarchical level as the motion compensation block being encoded through the operation shown in FIG. 15, the predicted motion vector information generation unit 34 determines that the predicted motion vector information has been generated based on a block belonging to the same hierarchical level as the motion compensation block being encoded. When an adjacent motion compensation block such as an anchor block that is temporally adjacent to the motion compensation block being encoded has a block size of the same hierarchical level as the motion compensation block being encoded, and predicted motion vector information has been generated based on the motion vector information about the anchor block, the predicted motion vector information generation unit 34 determines that temporally predicted motion vector information has been generated based on a block belonging to the same hierarchical level as the motion compensation block being encoded. When spatially and temporally predicted motion vector information has been generated based on a block belonging to the same hierarchical level as the motion compensation block being encoded, the predicted motion vector information generation unit 34 moves on to step ST72. When at least spatially predicted motion vector information or temporally predicted motion vector information cannot be generated based on a block belonging to the same hierarchical level as the motion compensation block being encoded, the predicted motion vector information generation unit 34 moves on to step ST75.

In step ST72, the predicted motion vector information generation unit 34 determines whether the motion vectors are identical. When the motion vectors indicated by the spatially predicted motion vector information match the motion vectors indicated by the temporally predicted motion vector information, the predicted motion vector information generation unit 34 moves on to step ST73. When those motion vectors are not identical, the predicted motion vector information generation unit 34 moves on to step ST74.

In step ST73, the predicted motion vector information generation unit 34 determines either piece of the information to be predicted motion vector information. As the motion vectors are identical, the predicted motion vector information generation unit 34 outputs either the spatially predicted motion vector information or the temporally predicted motion vector information as the predicted motion vector information to the motion prediction/compensation unit 32.

In step ST74, the predicted motion vector information generation unit 34 performs an optimum predicted motion vector selecting operation. The predicted motion vector information generation unit 34 compares the cost function value obtained when the spatially predicted motion vector information is selected with the cost function value obtained when the temporally predicted motion vector information is selected, and outputs the information with a higher encoding efficiency as the predicted motion vector information to the motion prediction/compensation unit 32. Here, the cost function values are calculated by using the cost function value calculation unit 322 of the motion prediction/compensation unit 32.

In step ST75, the predicted motion vector information generation unit 34 determines whether the temporally predicted motion vector information has been generated based on a block belonging to the same hierarchical level as the motion compensation block being encoded. When the motion compensation block being encoded and the anchor block used in generating the temporally predicted motion vector information have block sizes of the same hierarchical level, the predicted motion vector information generation unit 34 determines that temporally predicted motion vector information has been generated, and moves on to step ST76. When the anchor block used in generating the temporally predicted motion vector information does not have a block size of the same hierarchical level, the predicted motion vector information generation unit 34 moves on to step ST77.

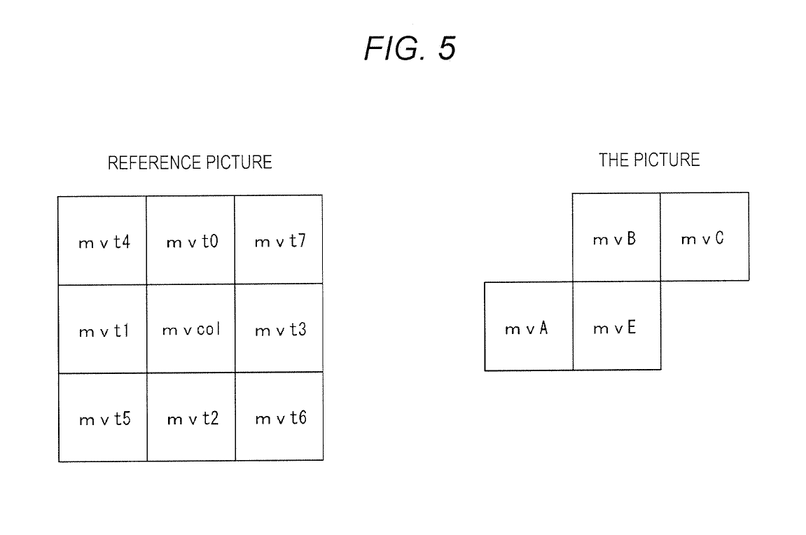

In step ST76, the predicted motion vector information generation unit 34 determines the temporally predicted motion vector information to be predicted motion vector information. The predicted motion vector information generation unit 34 determines the temporally predicted motion vector information calculated as described above with reference to FIG. 5 to be the predicted motion vector information, and outputs the predicted motion vector information to the motion prediction/compensation unit 32.

In step ST77, the predicted motion vector information generation unit 34 determines whether the spatially predicted motion vector information has been generated based on a block belonging to the same hierarchical level as the motion compensation block being encoded. When the spatially predicted motion vector information has been generated by using the motion vector information about an encoded adjacent motion compensation block having a block size of the same hierarchical level as the motion compensation block being encoded, the predicted motion vector information generation unit 34 moves on to step ST78. When spatially predicted motion vector information cannot be generated by using the motion vector information about an encoded adjacent motion compensation block having a block size of the same hierarchical level, the predicted motion vector information generation unit 34 moves on to step ST79.

In step ST78, the predicted motion vector information generation unit 34 determines the spatially predicted motion vector information to be the predicted motion vector information. The predicted motion vector information generation unit 34 determines the spatially predicted motion vector information generated through the procedures of steps ST61 through ST68 of FIG. 15 to be the predicted motion vector information, and outputs the predicted motion vector information to the motion prediction/compensation unit 32.

In step ST79, the predicted motion vector information generation unit 34 determines zero-vector information to be the predicted motion vector information. Since the spatially and temporally predicted motion vector information has not been generated based on an adjacent motion compensation block belonging to the same hierarchical level as the motion compensation block being encoded, the predicted motion vector information generation unit 34 determines the motion vector information indicating a zero-vector to be the predicted motion vector information. The predicted motion vector information generation unit 34 outputs the predicted motion vector information indicating the zero-vector to the motion prediction/compensation unit 32.

As described above, when predicted motion vector information is generated by using not only spatial blocks but also temporal blocks, the predicted motion vector information can be more suitably optimized than in a case where predicted motion vector information is generated by using only spatially adjacent motion compensation blocks. When spatially predicted motion vector information and temporally predicted motion vector information can be generated, the predicted motion vector information generation unit 34 generates identification information for identifying which information has been selected, as well as the predicted motion vector information. In this manner, the same predicted motion vector information as the predicted motion vector information generated at the time of encoding can be generated at the time of decoding.

Referring back to FIG. 14, in step ST53, the motion prediction/compensation unit 32 performs a motion vector encoding operation. The cost function value calculation unit 322 of the motion prediction/compensation unit 32 generates difference motion vector information by calculating difference motion vectors that are the differences between the motion vectors detected by the motion search unit 321 and the predicted motion vectors generated by the predicted motion vector information generation unit 34. The cost function value calculation unit 322 also generates difference motion vector information in all the prediction modes.

In step ST54, the motion prediction/compensation unit 32 calculates a cost function value in each prediction mode. Using the above mentioned equation (9) or (10), the motion prediction/compensation unit 32 calculates the cost function values. Using the difference motion vector information, the motion prediction/compensation unit 32 also calculates a bit generation rate. The cost function value calculations in the inter prediction modes involve the evaluations of cost function values in the skipped macroblock mode or the direct mode specified in H.264/AVC.

In step ST55, the motion prediction/compensation unit 32 determines the optimum inter prediction mode. Based on the cost function values calculated in step ST54, the motion prediction/compensation unit 32 selects the one prediction mode with the smallest cost function value among the calculated cost function values, and determines the selected prediction mode to be the optimum inter prediction mode.

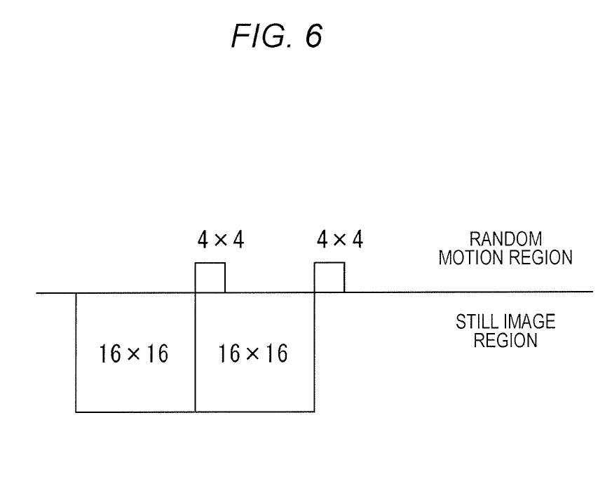

As described above, the image encoding device 10 selects an adjacent motion compensation block, in accordance with the block sizes of the motion compensation block being encoded and the encoded adjacent motion compensation blocks spatially and temporally adjacent to the motion compensation block being encoded. Also, the image encoding device 10 generates predicted motion vector information by using the motion vector information about the selected adjacent motion compensation block. That is, predicted motion vector information is generated by adaptively using the motion vector information about an adjacent motion compensation block in accordance with the block sizes of the current motion compensation block being processed and the adjacent motion compensation blocks. Accordingly, predicted motion vector information can be generated in accordance with the result of detection of discontinuity appearing on a motion boundary, and a high encoding efficiency can be realized. For example, in the motion vector encoding operation in the still image region shown in FIG. 6, predicted motion vector information is generated without the use of the motion vector information about an adjacent motion compensation block having a small block size in the random motion region. Accordingly, the efficiency in the motion vector encoding operation can be increased.

### [3. Structure of an Image Decoding Device]

Next, an image decoding device is described. Compressed image information generated by encoding an input image is supplied to an image decoding device via a predetermined transmission path or a recording medium or the like, and is decoded therein.

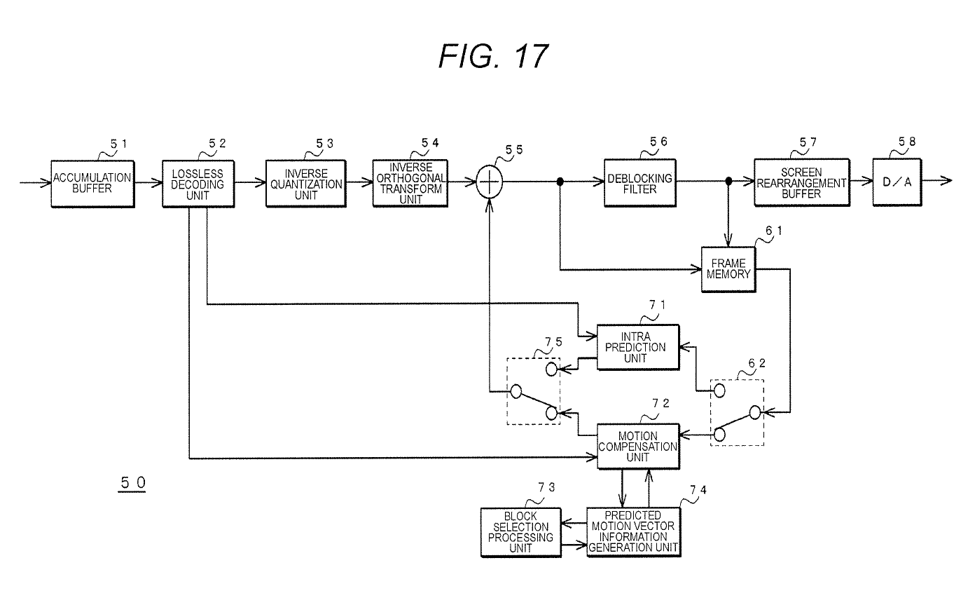

FIG. 17 shows the structure of an image processing device that decodes compressed image information (hereinafter referred to as the “image decoding device”). The image decoding device 50 includes an accumulation buffer 51, a lossless decoding unit 52, an inverse quantization unit 53, an inverse orthogonal transform unit 54, an addition unit 55, a deblocking filter 56, a screen rearrangement buffer 57, and a digital/analog converter (a D/A converter) 58. The image decoding device 50 further includes a frame memory 61, selectors 62 and 75, an intra prediction unit 71, a motion compensation unit 72, a block selection processing unit 73, and a predicted motion vector information generation unit 74.

The accumulation buffer 51 stores transmitted compressed image information. The lossless decoding unit 52 decodes the compressed image information supplied from the accumulation buffer 51 by a technique compatible with the encoding technique used by the lossless encoding unit 16 of FIG. 7.

The lossless decoding unit 52 outputs the prediction mode information obtained by decoding the compressed image information to the intra prediction unit 71 and the motion compensation unit 72.

The inverse quantization unit 53 inversely quantizes the quantized data decoded by the lossless decoding unit 52, using a technique compatible with the quantization technique used by the quantization unit 15 of FIG. 7. The inverse orthogonal transform unit 54 performs an inverse orthogonal transform on the output from the inverse quantization unit 53 by a technique compatible with the orthogonal transform technique used by the orthogonal transform unit 14 of FIG. 7, and outputs the result to the addition unit 55.

The addition unit 55 generates decoded image data by adding the data subjected to the inverse orthogonal transform to predicted image data supplied from the selector 75, and outputs the decoded image data to the deblocking filter 56 and the frame memory 61.

The deblocking filter 56 performs a deblocking filtering operation on the decoded image data supplied from the addition unit 55, and removes block distortions. The resultant data is supplied to and stored in the frame memory 61, and is also output to the screen rearrangement buffer 57.

The screen rearrangement buffer 57 performs image rearrangement. Specifically, the frame order rearranged in the order of encoding at the screen rearrangement buffer 12 of FIG. 7 is rearranged in the original display order, and is output to the D/A converter 58.

The D/A converter 58 performs a D/A conversion on the image data supplied from the screen rearrangement buffer 57, and outputs the converted image data to a display (not shown) to display the images.

The frame memory 61 stores the decoded image data yet to be subjected to the filtering operation at the deblocking filter 24, and the decoded image data subjected to the filtering operation at the deblocking filter 24.

Based on the prediction mode information supplied from the lossless decoding unit 52, the selector 62 supplies the decoded image data that is yet to be subjected to the filtering operation and is stored in the frame memory 61, to the intra prediction unit 71, when intra-predicted image decoding is performed. When inter-predicted image decoding is performed, the selector 62 supplies the decoded image data that has been subjected to the filtering operation and is stored in the frame memory 61, to the motion compensation unit 72.

Based on the prediction mode information supplied from the lossless decoding unit 52 and the decoded image data supplied from the frame memory 61 via the selector 62, the intra prediction unit 71 generates predicted image data, and outputs the generated predicted image data to the selector 75.

The motion compensation unit 72 adds difference motion vector information supplied from the lossless decoding unit 52 to predicted motion vector information supplied from the predicted motion vector information generation unit 74, to generate the motion vector information about the motion compensation block being decoded. Based on the generated motion vector information and the prediction mode information supplied from the lossless decoding unit 52, the motion compensation unit 72 also performs motion compensation to generate predicted image data by using the decoded image data supplied from the frame memory 61, and outputs the predicted image data to the selector 75.

The block selection processing unit 73 selects a block from adjacent motion compensation blocks, in accordance with the block size of the motion compensation block being decoded and the block sizes of the encoded adjacent motion compensation blocks adjacent to this motion compensation block. The block selection processing unit 73 selects only the adjacent motion compensation block that has been encoded in a size of the same hierarchical level as the motion compensation block being decoded, and outputs the block selection result to the predicted motion vector information generation unit 74.

The predicted motion vector information generation unit 74 generates the predicted motion vector information to be used in decoding the motion vector information about the motion compensation block being decoded, using the motion vector information about the block selected by the block selection processing unit 73. The predicted motion vector information generation unit 74 also outputs the generated predicted motion vector information to the motion compensation unit 72.

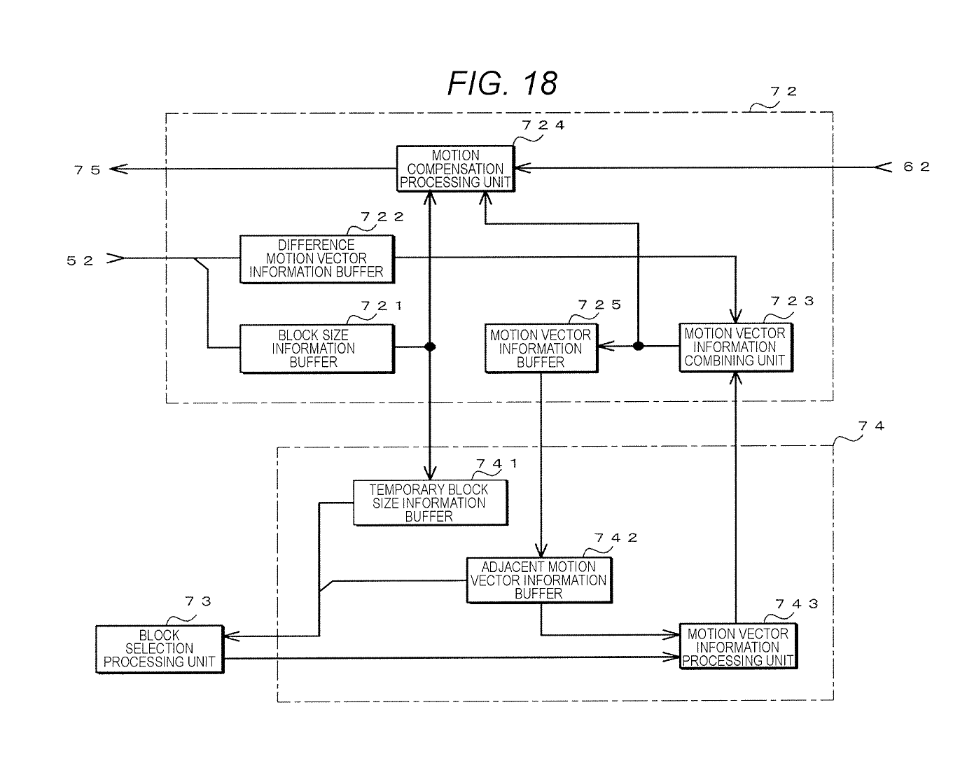

FIG. 18 illustrates the structures of the motion compensation unit 72 and the predicted motion vector information generation unit 74.

The motion compensation unit 72 includes a block size information buffer 721, a difference motion vector information buffer 722, a motion vector information combining unit 723, a motion compensation processing unit 724, and a motion vector information buffer 725.

The block size information buffer 721 stores information indicating the block size of the motion compensation block supplied from the lossless decoding unit 52. The block size information buffer 721 also outputs stored information indicating macroblock sizes to the motion compensation processing unit 724 and the predicted motion vector information generation unit 74.

The difference motion vector information buffer 722 stores the difference motion vector information about the motion compensation block supplied from the lossless decoding unit 52. The difference motion vector information buffer 722 also outputs the stored difference motion vector information to the motion vector information combining unit 723.

The motion vector information combining unit 723 adds the difference motion vector information supplied from the difference motion vector information buffer 722 to the predicted motion vector information generated at the predicted motion vector information generation unit 74. The motion vector information combining unit 723 outputs the motion vector information about the motion compensation block obtained by adding the difference motion vector information to the predicted motion vector information, to the motion compensation processing unit 724 and the motion vector information buffer 725.

Based on the prediction mode information supplied from the lossless decoding unit 52, the motion compensation processing unit 724 reads the image data of a reference image from the frame memory 61. Based on the image data of the reference image, the block size of the motion compensation block supplied from the block size information buffer 721, and the motion vector information about the motion compensation block supplied from the motion vector information combining unit 723, the motion compensation processing unit 724 performs motion compensation, to generate predicted image data. The motion compensation processing unit 724 outputs the generated predicted image data to the selector 75.

The motion vector information buffer 725 stores the motion vector information supplied from the motion vector information combining unit 723. The motion vector information buffer 725 also outputs predicted motion vector information to the predicted motion vector information generation unit 74.

The predicted motion vector information generation unit 74 includes a temporary block size information buffer 741, an adjacent motion vector information buffer 742, and a motion vector information processing unit 743.

The temporary block size information buffer 741 stores adjacent motion compensation block size information supplied from the block size information buffer 721 of the motion compensation unit 72. The temporary block size information buffer 741 also outputs the stored adjacent motion compensation block size information to the block selection processing unit 73.

The adjacent motion vector information buffer 742 stores the adjacent motion vector information supplied from the motion vector information buffer 725 of the motion compensation unit 72. The adjacent motion vector information buffer 742 also outputs the stored adjacent motion vector information to the motion vector information processing unit 743.

Based on the block selection result supplied from the block selection processing unit 73, the motion vector information processing unit 743 selects the motion vector information about the adjacent motion compensation block indicated by the block selection result, and generates predicted motion vector information. The motion vector information processing unit 743 outputs the generated predicted motion vector information to the motion vector information combining unit 723 of the motion compensation unit 72.

Referring back to FIG. 17, based on the prediction mode information supplied from the lossless decoding unit 52, the selector 75 selects the intra prediction unit 71 in the case of an intra prediction, and selects the motion compensation unit 72 in the case of an inter prediction. The selector 75 outputs the predicted image data generated at the selected intra prediction unit 71 or motion compensation unit 72 to the addition unit 55.

### [4. Operations of the Image Decoding Apparatus]

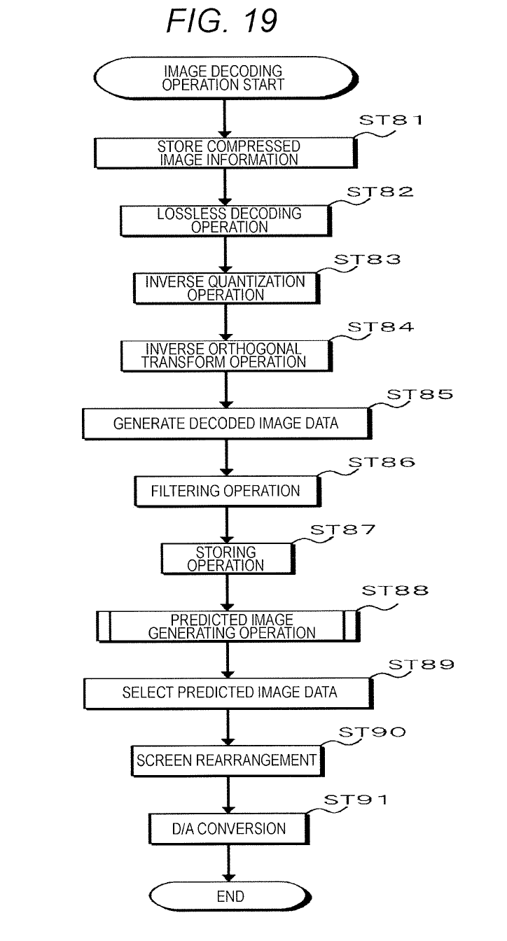

Referring now to the flowchart in FIG. 19, an image decoding operation to be performed by the image decoding device 50 is described.

In step ST81, the accumulation buffer 51 stores transmitted compressed image information. In step ST82, the lossless decoding unit 52 performs a lossless decoding operation. The lossless decoding unit 52 decodes the compressed image information supplied from the accumulation buffer 51. Specifically, the quantized data of each picture encoded at the lossless encoding unit 16 of FIG. 7 is obtained. The lossless decoding unit 52 also performs lossless decoding on the prediction mode information contained in the compressed image information. When the obtained prediction mode information is information about an intra prediction mode, the prediction mode information is output to the intra prediction unit 71. When the prediction mode information is information about an inter prediction mode, on the other hand, the lossless decoding unit 52 outputs the prediction mode information to the motion compensation unit 72.

In step ST83, the inverse quantization unit 53 performs an inverse quantization operation. The inverse quantization unit 53 inversely quantizes the quantized data decoded by the lossless decoding unit 52, having characteristics compatible with the characteristics of the quantization unit 15 of FIG. 7.

In step ST84, the inverse orthogonal transform unit 54 performs an inverse orthogonal transform operation.

The inverse orthogonal transform unit 54 performs an inverse orthogonal transform on the transform coefficient data inversely quantized by the inverse quantization unit 53, having the characteristics compatible with the characteristics of the orthogonal transform unit 14 of FIG. 7.

In step ST85, the addition unit 55 generates decoded image data. The addition unit 55 adds the data obtained through the inverse orthogonal transform operation to predicted image data selected in step ST89, which will be described later, and generates the decoded image data. In this manner, the original images are decoded.

In step ST86, the deblocking filter 56 performs a filtering operation. The deblocking filter 56 performs a deblocking filtering operation on the decoded image data output from the addition unit 55, and removes block distortions contained in the decoded images.

In step ST87, the frame memory 61 performs a decoded image data storing operation.

In step ST88, the intra prediction unit 71 and the motion compensation unit 72 perform predicted image generating operations. The intra prediction unit 71 and the motion compensation unit 72 each perform a predicted image generating operation in accordance with the prediction mode information supplied from the lossless decoding unit 52.

Specifically, when prediction mode information about an intra prediction has been supplied from the lossless decoding unit 52, the intra prediction unit 71 generates predicted image data based on the prediction mode information. When prediction mode information about an inter prediction has been supplied from the lossless decoding unit 52, on the other hand, the motion compensation unit 72 performs motion compensation based on the prediction mode information, to generate predicted image data.

In step ST89, the selector 75 selects predicted image data. The selector 75 selects the predicted image supplied from the intra prediction unit 71 and the predicted image data supplied from the motion compensation unit 72, and supplies the selected predicted image data to the addition unit 55, which adds the selected predicted image data to the output from the inverse orthogonal transform unit 54 in step ST85, as described above.

In step ST90, the screen rearrangement buffer 57 performs image rearrangement. Specifically, the order of frames rearranged for encoding by the screen rearrangement buffer 12 of the image encoding device 10 of FIG. 7 is rearranged in the original display order by the screen rearrangement buffer 57.

In step ST91, the D/A converter 58 performs a D/A conversion on the image data supplied from the screen rearrangement buffer 57. The images are output to the display (not shown), and are displayed.

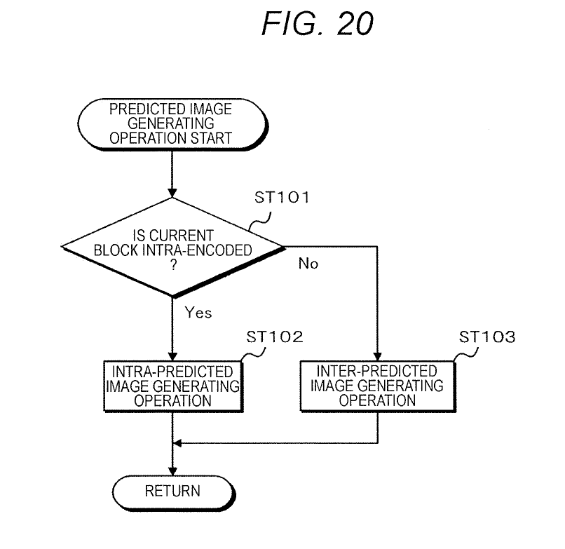

Referring now to the flowchart in FIG. 20, the predicted image generating operation in step ST88 of FIG. 19 is described.

In step ST101, the lossless decoding unit 52 determines whether the target block has been intra-encoded. When the prediction mode information obtained by performing lossless decoding is prediction mode information about an intra prediction, the lossless decoding unit 52 supplies the prediction mode information to the intra prediction unit 71, and moves on to step ST102. When the prediction mode information is prediction mode information about an inter prediction mode, on the other hand, the lossless decoding unit 52 supplies the prediction mode information to the motion compensation unit 72, and moves on to step ST103.

In step ST102, the intra prediction unit 71 performs an intra-predicted image generating operation. Using the prediction mode information and the decoded image data that has not been subjected to the deblocking filtering operation and is stored in the frame memory 61, the intra prediction unit 71 performs an intra prediction, to generate predicted image data.

In step ST103, the motion compensation unit 72 performs an inter-predicted image generating operation. Based on the prediction mode information and difference motion vector information supplied from the lossless decoding unit 52, the motion compensation unit 72 performs motion compensation on a reference image read from the frame memory 61, and generates predicted image data.

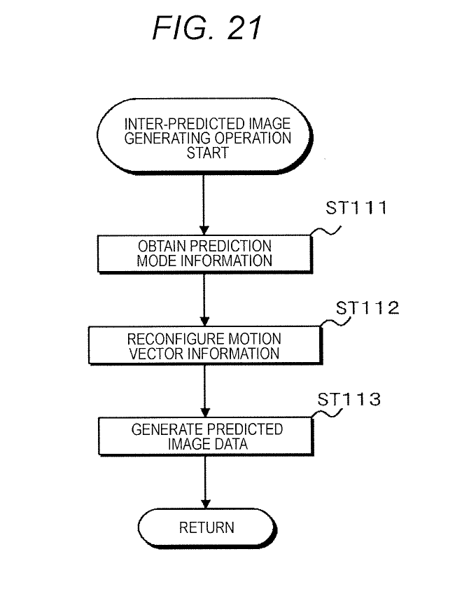

FIG. 21 is a flowchart showing the inter-predicted image generating operation of step ST103. In step ST111, the motion compensation unit 72 obtains prediction mode information. The motion compensation unit 72 obtains the prediction mode information from the lossless decoding unit 52, and moves on to step ST112.

In step ST112, the motion compensation unit 72 reconfigures motion vector information. The motion compensation unit 72 reconfigures motion vector information based on predicted motion vector information generated at the predicted motion vector information generation unit 74 and the difference motion vector information indicated by the prediction mode information, and then moves on to step ST113. The predicted motion vector information is generated as described above with reference to FIGS. 15 and 16. That is, the block selection processing unit 73 performs the same operation as the operation performed by the block selection processing unit 33 of the image encoding device 10, and the predicted motion vector information generation unit 74 performs the same operation as the operation performed by the predicted motion vector information generation unit 34 of the image encoding device 10.

In step ST113, the motion compensation unit 72 generates predicted image data. Based on the prediction mode information obtained in step ST111 and the motion vector information reconfigured in step ST112, the motion compensation unit 72 performs motion compensation by reading the reference image data from the frame memory 61, and generates and outputs predicted image data to the selector 75.

As described above, the image decoding device 50 selects an adjacent motion compensation block, in accordance with the block sizes of the motion compensation block being decoded and the encoded adjacent motion compensation blocks spatially and temporally adjacent to the motion compensation block being decoded. Also, the image decoding device 50 generates predicted motion vector information by using the motion vector information about the selected adjacent motion compensation block. That is, predicted motion vector information that is the same as the predicted motion vector information generated in the image encoding device 10 is generated by adaptively using the motion vector information about an adjacent motion compensation block in accordance with the block sizes of the motion compensation block being processed and the adjacent motion compensation blocks. Accordingly, based on the generated predicted motion vector information and the difference motion vector information supplied from the image encoding device 10, the image decoding device 50 can correctly uncompress the motion vector information about the motion compensation block being decoded.

When two adjacent motion compensation blocks have block sizes of the same hierarchical level, the identification information indicating the mean value or the block using motion vector information between the two adjacent motion compensation blocks is incorporated as information necessary for generating the predicted motion vector information, into compressed image information. Also, the identification information indicating which of the spatially predicted motion vector information and the temporally predicted motion vector information has been used as the predicted motion vector information is incorporated into the compressed image information. Accordingly, predicted motion vector information can be correctly generated by using the identification information, and a large increase in the total bit rate of the compressed image information is prevented.

### [5. Software Processing]

The series of operations described in this specification can be performed by hardware, software, or a combination of hardware and software. When operations are performed by software, a program in which the operation sequences are recorded is installed in a memory incorporated into specialized hardware in a computer. Alternatively, the operations can be performed by installing the program into a general-purpose computer that can perform various kinds of operations.

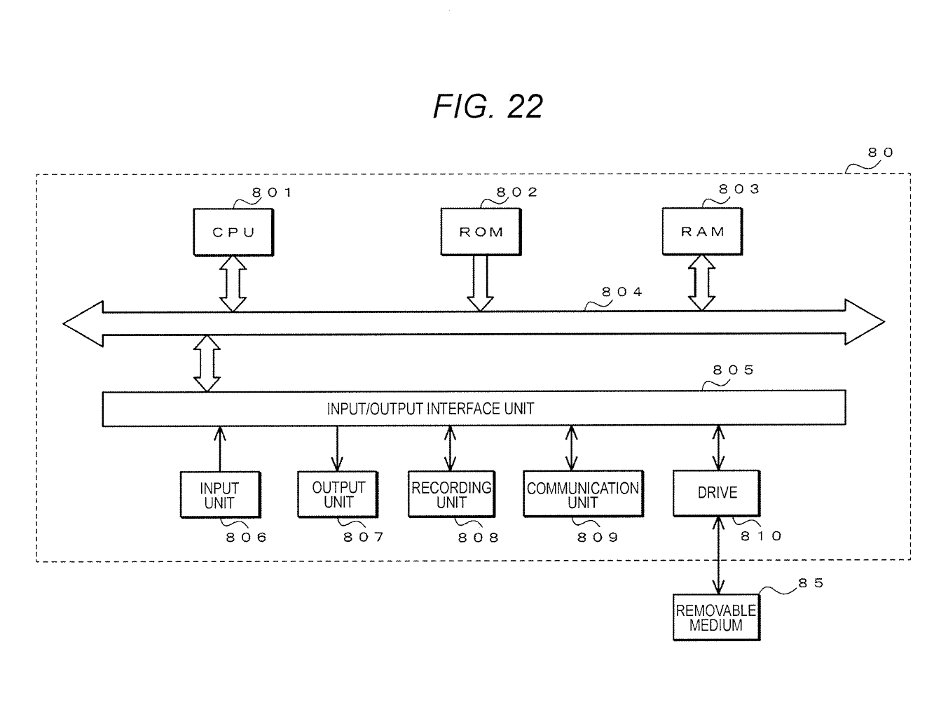

FIG. 22 is a diagram showing an example structure of a computer device that performs the above described series of operations in accordance with a program. A CPU 801 of a computer device 80 performs various kinds of operations in accordance with a program recorded on a ROM 802 or a recording unit 808.

Programs to be executed by the CPU 801 and data are stored in a RAM 803 as appropriate. The CPU 801, the ROM 802, and the RAM 803 are connected to one another by a bus 804.

An input/output interface 805 is also connected to the CPU 801 via the bus 804. An input unit 806 such as a touch panel, a keyboard, a mouse, or a microphone, and an output unit 807 formed with a display or the like are connected to the input/output interface 805. The CPU 801 performs various kinds of operations in accordance with instructions input through the input unit 806. The CPU 801 outputs the operation results to the output unit 807.

The recording unit 808 connected to the input/output interface 805 is formed with a hard disk, for example, and records programs to be executed by the CPU 801 and various kinds of data. A communication unit 809 communicates with an external device via a wired or wireless communication medium such as a network like the Internet or a local area network, or digital broadcasting. Alternatively, the computer device 80 may obtain a program via the communication unit 809, and record the program on the ROM 802 or the recording unit 808.

When a removable medium 85 that is a magnetic disk, an optical disk, a magnetooptical disk, a semiconductor memory, or the like is mounted, a drive 810 drives the removable medium 85, to obtain a recorded program or recorded data. The obtained program or data is transferred to the ROM 802, the RAM 803, or the recording unit 808, where necessary.

The CPU 801 reads and executes the program for performing the above described series of operations, to perform encoding operations on image signals recorded on the recording unit 808 or the removable medium 85 and on image signals supplied via the communication unit 809, and perform decoding operations on compressed image information.

### [6. Applications to Electronic Apparatuses]

In the above described examples, H.264/AVC is used as the encoding/decoding technique. However, the present technique can be applied to image encoding devices and image decoding devices that use other encoding/decoding techniques for performing motion prediction/compensation operations.

Further, the present technique can be used when image information (bit streams) compressed through orthogonal transforms such as discrete cosine transforms and motion compensation as in MPEG or H.26x, for example, is received via a network medium such as satellite broadcasting, cable TV (television), the Internet, or a portable telephone device. The present technique can also be applied to image encoding devices and image decoding devices that are used when compressed image information is processed on a storage medium such as an optical or magnetic disk or a flash memory.

The above described image encoding device 10 and the image decoding device 50 can be applied to any electronic apparatuses. The following is a description of such examples.

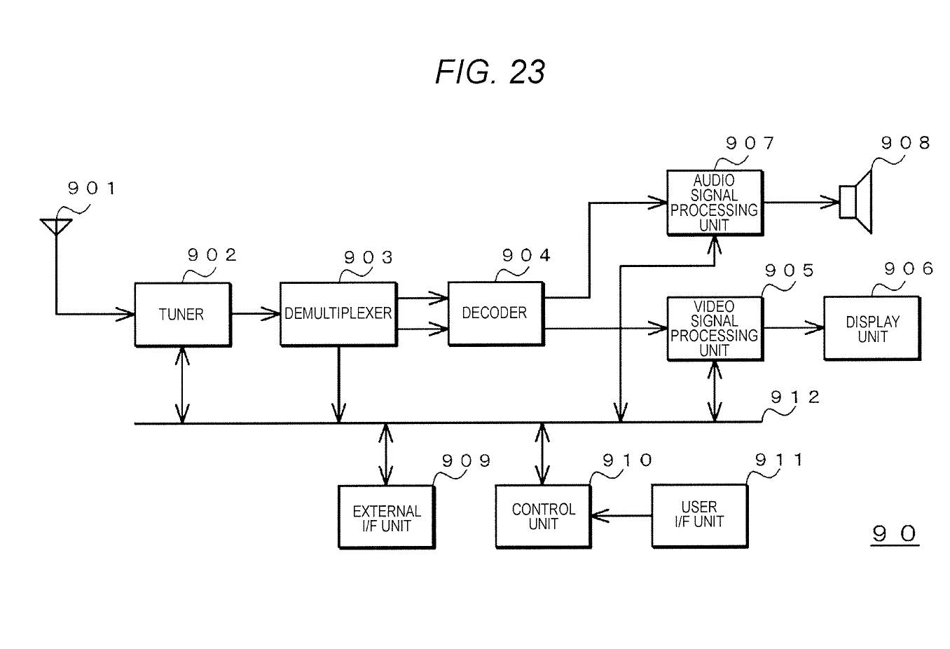

FIG. 23 schematically shows an example structure of a television apparatus to which the present technique is applied. The television apparatus 90 includes an antenna 901, a tuner 902, a demultiplexer 903, a decoder 904, a video signal processing unit 905, a display unit 906, an audio signal processing unit 907, a speaker 908, and an external interface unit 909. The television apparatus 90 further includes a control unit 910, a user interface unit 911, and the like.

The tuner 902 selects a desired channel from broadcast wave signals received at the antenna 901, and performs demodulation. The resultant stream is output to the demultiplexer 903.

The demultiplexer 903 extracts the video and audio packets of the show to be viewed from the stream, and outputs the data of the extracted packet to the decoder 904. The demultiplexer 903 also outputs a packet of data such as EPG (Electronic Program Guide) to the control unit 910. Where scrambling is performed, the demultiplexer or the like cancels the scrambling.

The decoder 904 performs a packet decoding operation, and outputs the video data generated through the decoding operation to the video signal processing unit 905, and the audio data to the audio signal processing unit 907.

The video signal processing unit 905 subjects the video data to a noise removal and video processing or the like in accordance with user settings. The video signal processing unit 905 generates video data of the show to be displayed on the display unit 906, or generates image data or the like through an operation based on an application supplied via a network. The video signal processing unit 905 also generates video data for displaying a menu screen or the like for item selection, and superimposes the video data on the video data of the show. Based on the video data generated in this manner, the video signal processing unit 905 generates a drive signal to drive the display unit 906.

Based on the drive signal from the video signal processing unit 905, the display unit 906 drives a display device (a liquid crystal display element, for example) to display the video of the show.

The audio signal processing unit 907 subjects the audio data to predetermined processing such as a noise removal, and performs a D/A conversion operation and an amplification operation on the processed audio data. The resultant audio data is supplied as an audio output to the speaker 908.

The external interface unit 909 is an interface for a connection with an external device or a network, and transmits and receives data such as video data and audio data.

The user interface unit 911 is connected to the control unit 910. The user interface unit 911 is formed with operation switches, a remote control signal reception unit, and the like, and supplies an operating signal according to a user operation to the control unit 910.

The control unit 910 is formed with a CPU (Central Processing Unit), a memory, and the like. The memory stores the program to be executed at the CPU, various kinds of data necessary for the CPU to perform operations, EPG data, data obtained via a network, and the like. The program stored in the memory is read and executed at the CPU at a predetermined time such as the time of activation of the television apparatus 90. The CPU executes the program to control the respective components so that the television apparatus 90 operates in accordance with user operations.

In the television apparatus 90, a bus 912 is provided for connecting the tuner 902, the demultiplexer 903, the video signal processing unit 905, the audio signal processing unit 907, the external interface unit 909, and the like to the control unit 910.

In the television apparatus having such a structure, the decoder 904 has the functions of an image decoding device (an image decoding method) of the present invention. Accordingly, based on generated predicted motion vector information and received difference motion vector information, the television apparatus can correctly restore the motion vector information about motion compensation blocks to be decoded. Even if the broadcasting side performs a motion vector encoding operation by using the predicted motion vector information generated in accordance with the block sizes of the motion compensation block being encoded and the encoded adjacent motion compensation blocks, the television apparatus can perform correct decoding.

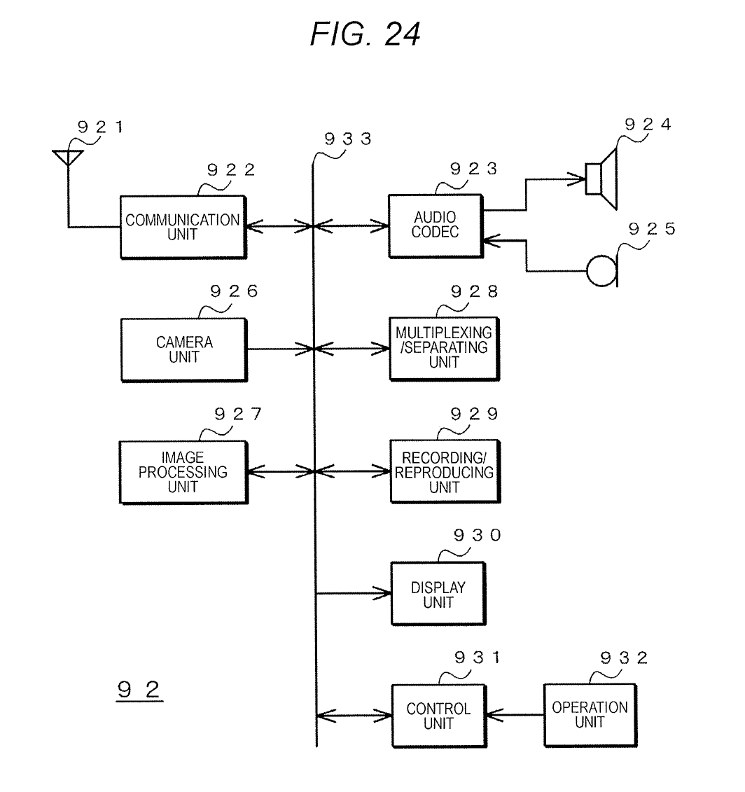

FIG. 24 schematically shows an example structure of a portable telephone device to which the present technique is applied. The portable telephone device 92 includes a communication unit 922, an audio codec 923, a camera unit 926, an image processing unit 927, a multiplexing/separating unit 928, a recording/reproducing unit 929, a display unit 930, and a control unit 931. Those components are connected to one another via a bus 933.

Also, an antenna 921 is connected to the communication unit 922, and a speaker 924 and a microphone 925 are connected to the audio codec 923. Further, an operation unit 932 is connected to the control unit 931.

The portable telephone device 92 performs various kinds of operations such as transmission and reception of audio signals, transmission and reception of electronic mail and image data, image capturing, and data recording, in various kinds of modes such as an audio communication mode and a data communication mode.

In the audio communication mode, an audio signal generated at the microphone 925 is converted into audio data, and the data is compressed at the audio codec 923. The compressed data is supplied to the communication unit 922. The communication unit 922 performs a modulation operation, a frequency conversion operation, and the like on the audio data, to generate a transmission signal. The communication unit 922 also supplies the transmission signal to the antenna 921, and the transmission signal is transmitted to a base station (not shown). The communication unit 922 also amplifies a signal received at the antenna 921, and performs a frequency conversion operation, a demodulation operation, and the like. The resultant audio data is supplied to the audio codec 923. The audio codec 923 decompresses audio data, and converts the audio data into an analog audio signal. The analog audio signal is then output to the speaker 924.

When mail transmission is performed in the data communication mode, the control unit 931 receives text data that is input by operating the operation unit 932, and the input text is displayed on the display unit 930. In accordance with a user instruction or the like through the operation unit 932, the control unit 931 generates and supplies mail data to the communication unit 922. The communication unit 922 performs a modulation operation, a frequency conversion operation, and the like on the mail data, and transmits the resultant transmission signal from the antenna 921. The communication unit 922 also amplifies a signal received at the antenna 921, and performs a frequency conversion operation, a demodulation operation, and the like, to restore the mail data. This mail data is supplied to the display unit 930, and the content of the mail is displayed.

The portable telephone device 92 can cause the recording/reproducing unit 929 to store received mail data into a storage medium. The storage medium is a rewritable storage medium. For example, the storage medium may be a semiconductor memory such as a RAM or an internal flash memory, a hard disk, or a removable medium such as a magnetic disk, a magnetooptical disk, an optical disk, a USB memory, or a memory card.

When image data is transmitted in the data communication mode, image data generated at the camera unit 926 is supplied to the image processing unit 927. The image processing unit 927 performs an encoding operation on the image data, to generate compressed image information.

The multiplexing/separating unit 928 multiplexes the compressed image information generated at the image processing unit 927 and the audio data supplied from the audio codec 923 by a predetermined technique, and supplies the multiplexed data to the communication unit 922. The communication unit 922 performs a modulation operation, a frequency conversion operation, and the like on the multiplexed data, and transmits the resultant transmission signal from the antenna 921. The communication unit 922 also amplifies a signal received at the antenna 921, and performs a frequency conversion operation, a demodulation operation, and the like, to restore the multiplexed data. This multiplexed data is supplied to the multiplexing/separating unit 928. The multiplexing/separating unit 928 divides the multiplexed data, and supplies the compressed image information to the image processing unit 927, and the audio data to the audio codec 923.

The image processing unit 927 performs a decoding operation on the compressed image information, to generate image data. This image data is supplied to the display unit 930, to display the received images. The audio codec 923 converts the audio data into an analog audio signal and outputs the analog audio signal to the speaker 924, and the received sound is output.

In the portable telephone device having the above structure, the image processing unit 927 has the functions of an image processing device (an image processing method) of the present invention. Accordingly, when images are transmitted, predicted motion vector information is generated in accordance with the results of detection of discontinuity appearing on a motion boundary based on the block sizes of the motion compensation block being encoded and the adjacent motion compensation blocks. Thus, encoding efficiency of motion vector encoding operations can be increased. Also, compressed image information generated through image encoding operations can be correctly decoded.

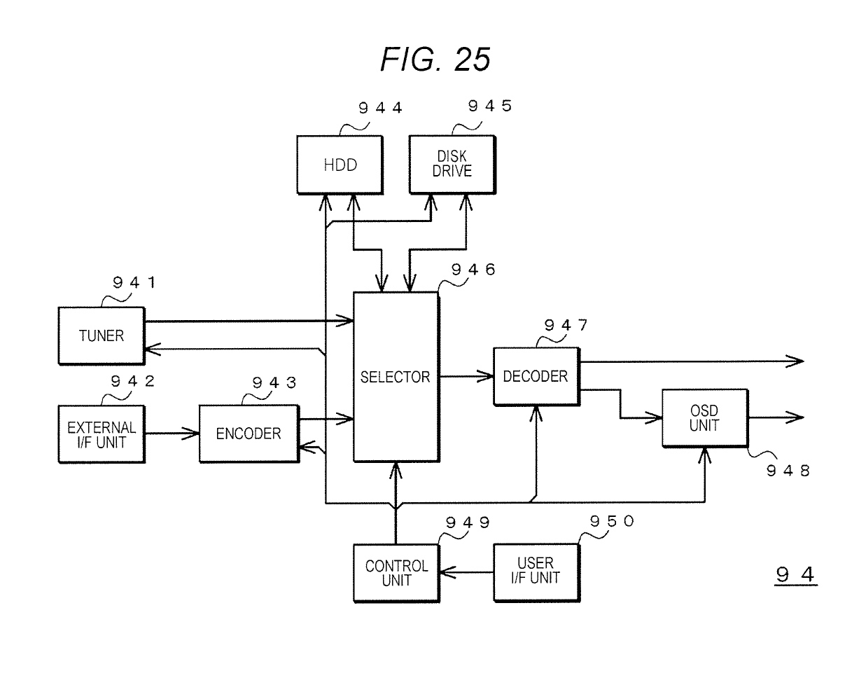

FIG. 25 schematically shows an example structure of a recording/reproducing apparatus to which the present technique is applied. The recording/reproducing apparatus 94 records the audio data and video data of a received broadcast show on a recording medium, and provides the recorded data to a user at a time according to an instruction from the user. The recording/reproducing apparatus 94 can also obtain audio data and video data from another apparatus, for example, and record the data on a recording medium. Further, the recording/reproducing apparatus 94 decodes and outputs audio data and video data recorded on a recording medium, so that a monitor device or the like can display images and outputs sound.

The recording/reproducing apparatus 94 includes a tuner 941, an external interface unit 942, an encoder 943, a HDD (Hard Disk Drive) unit 944, a disk drive 945, a selector 946, a decoder 947, an OSD (On-Screen Display) unit 948, a control unit 949, and a user interface unit 950.

The tuner 941 selects a desired channel from broadcast signals received at an antenna (not shown). The tuner 941 demodulates the received signal of the desired channel, and outputs the resultant compressed image information to the selector 946.

The external interface unit 942 is formed with at least one of an IEEE1394 interface, a network interface unit, a USB interface, a flash memory interface, and the like. The external interface unit 942 is an interface for a connection with an external device, a network, a memory card, or the like, and receives data such as video data and audio data to be recorded and the like.

The encoder 943 performs predetermined encoding on video data and audio data that have been supplied from the external interface unit 942 and have not been encoded, and outputs the compressed image information to the selector 946.

The HDD unit 944 records content data such as videos and sound, various kinds of programs, and other data on an internal hard disk, and reads the data from the hard disk at the time of reproduction or the like.

The disk drive 945 performs signal recording and reproduction on a mounted optical disk. The optical disk may be a DVD disk (such as a DVD-Video, a DVD-RAM, a DVD-R, a DVD-RW, a DVD+R, or a DVD+RW) or a Blu-ray disc, for example.

The selector 946 selects a stream from the tuner 941 or the encoder 943 at the time of video and audio recording, and supplies the stream to either the HDD unit 944 or the disk drive 945. The selector 946 also supplies a stream output from the HDD unit 944 or the disk drive 945 to the decoder 947 at the time of video and audio reproduction.

The decoder 947 performs a decoding operation on the stream. The decoder 947 supplies the video data generated by performing the decoding to the OSD unit 948. The decoder 947 also outputs the audio data generated by performing the decoding.

The OSD unit 948 also generates video data for displaying a menu screen or the like for item selection, and superimposes the video data on video data output from the decoder 947.

The user interface unit 950 is connected to the control unit 949. The user interface unit 950 is formed with operation switches, a remote control signal reception unit, and the like, and supplies an operating signal according to a user operation to the control unit 949.

The control unit 949 is formed with a CPU, a memory, and the like. The memory stores the program to be executed at the CPU and various kinds of data necessary for the CPU to perform operations. The program stored in the memory is read and executed by the CPU at a predetermined time such as the time of activation of the recording/reproducing apparatus 94. The CPU executes the program to control the respective components so that the recording/reproducing apparatus 94 operates in accordance with user operations.

In the recording/reproducing apparatus having the above structure, the encoder 943 has the functions of an image processing device (an image processing method) of the present invention. Accordingly, when images are recorded on a recording medium, predicted motion vector information is generated in accordance with the results of detection of discontinuity appearing on a motion boundary based on the block sizes of the motion compensation block being encoded and the adjacent motion compensation blocks. Thus, efficiency of motion vector encoding operations can be increased. Also, compressed image information generated through image encoding operations can be correctly decoded.

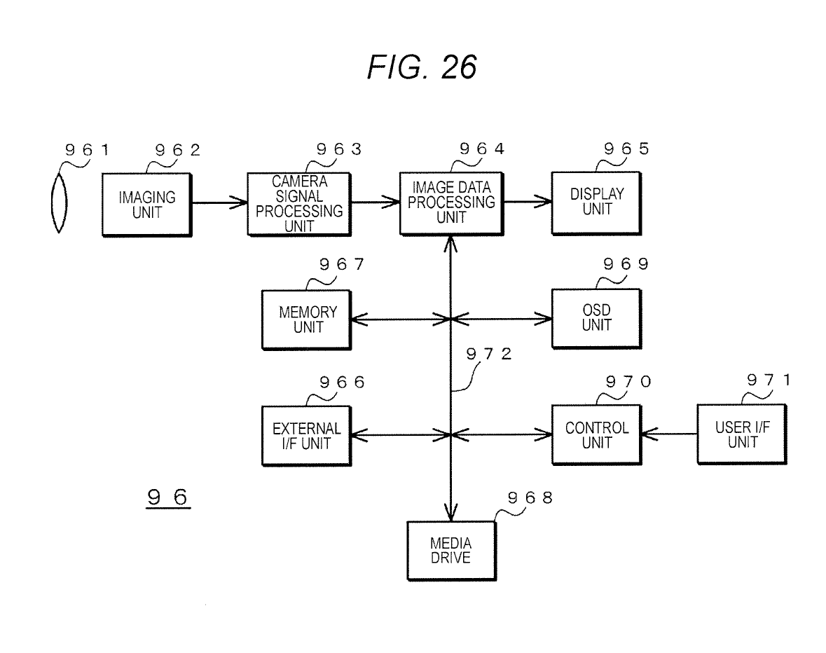

FIG. 26 schematically shows an example structure of an imaging apparatus to which the present technique is applied. An imaging apparatus 96 captures an image of an object, and causes a display unit to display the image of the object or records the image as image data on a recording medium.

The imaging apparatus 96 includes an optical block 961, an imaging unit 962, a camera signal processing unit 963, an image data processing unit 964, a display unit 965, an external interface unit 966, a memory unit 967, a media drive 968, an OSD unit 969, and a control unit 970. A user interface unit 971 is connected to the control unit 970. Further, the image data processing unit 964, the external interface unit 966, the memory unit 967, the media drive 968, the OSD unit 969, the control unit 970, and the like are connected via a bus 972.

The optical block 961 is formed with a focus lens, a diaphragm, and the like. The optical block 961 forms an optical image of an object on the imaging surface of the imaging unit 962. Formed with a CCD or a CMOS image sensor, the imaging unit 962 generates an electrical signal in accordance with the optical image through a photoelectric conversion, and supplies the electrical signal to the camera signal processing unit 963.

The camera signal processing unit 963 performs various kinds of camera signal processing such as a knee correction, a gamma correction, and a color correction on the electrical signal supplied from the imaging unit 962. The camera signal processing unit 963 supplies the image data subjected to the camera signal processing to the image data processing unit 964.

The image data processing unit 964 performs an encoding operation on the image data supplied from the camera signal processing unit 963. The image data processing unit 964 supplies the compressed image information generated by performing the encoding operation to the external interface unit 966 and the media drive 968. The image data processing unit 964 also performs a decoding operation on compressed image information supplied from the external interface unit 966 and the media drive 968. The image data processing unit 964 supplies the image data generated by performing the decoding operation to the display unit 965. The image data processing unit 964 also performs an operation to supply the image data supplied from the camera signal processing unit 963 to the display unit 965, or superimposes display data obtained from the OSD unit 969 on the image data and supplies the image data to the display unit 965.

The OSD unit 969 generates display data of a menu screen and icons formed with symbols, characters, or figures, and outputs the data to the image data processing unit 964.

The external interface unit 966 is formed with a USB input/output terminal and the like, for example, and is connected to a printer when image printing is performed. A drive is also connected to the external interface unit 966 where necessary, and a removable medium such as a magnetic disk or an optical disk is mounted on the drive as appropriate. A program read from such a removable medium is installed where necessary. Further, the external interface unit 966 includes a network interface connected to a predetermined network such as a LAN or the internet. The control unit 970 reads compressed image information from the memory unit 967 in accordance with an instruction from the user interface unit 971, for example, and can supply the compressed image information from the external interface unit 966 to another apparatus connected thereto via a network. The control unit 970 can also obtain, via the external interface unit 966, compressed image information or image data supplied from another apparatus via a network, and supply the compressed image information or image data to the image data processing unit 964.

A recording medium to be driven by the media drive 968 may be a readable/rewritable removable medium such as a magnetic disk, a magnetooptical disk, an optical disk, or a semiconductor memory. The recording medium may be any type of removable medium, and may be a tape device, a disk, or a memory card. The recording medium may of course be a non-contact IC card or the like.

Alternatively, the media drive 968 and a recording medium may be integrated, and may be formed with an immobile storage medium such as an internal hard disk drive or an SSD (Solid State Drive).

The control unit 970 is formed with a CPU, a memory, and the like. The memory stores the program to be executed at the CPU, and various kinds of data and the like necessary for the CPU to perform operations. The program stored in the memory is read and executed by the CPU at a predetermined time such as the time of activation of the imaging apparatus 96. The CPU executes the program to control the respective components so that the imaging apparatus 96 operates in accordance with user operations.

In the imaging apparatus having the above structure, the image data processing unit 964 has the functions of an image processing device (an image processing method) of the present invention. Accordingly, when captured images are recorded on the memory unit 967, a recording medium, or the like, predicted motion vector information is generated in accordance with the results of detection of discontinuity appearing on a motion boundary based on the block sizes of the motion compensation block being encoded and the adjacent motion compensation blocks. Thus, efficiency of motion vector encoding operations can be increased. Also, compressed image information generated through image encoding operations can be correctly decoded.

Further, the present technique should not be interpreted to be limited to the above described embodiments. The embodiments disclose the present technique through examples, and it should be obvious that those skilled in the art can modify or replace those embodiments with other embodiments without departing from the scope of the technique. That is, the claims should be taken into account in understanding the subject matter of the technique.

### INDUSTRIAL APPLICABILITY

In an image processing device, an image processing method, and a program according to this technique, a block is selected from adjacent motion compensation blocks, in accordance with the block size of the current motion compensation block being encoded or decoded and the block sizes of the encoded adjacent motion compensation blocks adjacent to the current motion compensation block. Also, predicted motion vector information about the current motion compensation block being processed is generated by using the motion vector information about the selected block. That is, predicted motion vector information is generated by adaptively using the motion vector information about an adjacent motion compensation block in accordance with the block sizes of the current motion compensation block being processed and the adjacent motion compensation blocks. Accordingly, predicted motion vector information can be generated in accordance with the result of detection of discontinuity appearing on a motion boundary, and a high encoding efficiency can be realized. In view of this, the technique is suitable for transmitting and receiving compressed image information (bit streams) via a network medium such as satellite broadcasting, cable TV, the Internet, or portable telephones, or for devices and the like that perform image recording and reproduction by using storage media such as optical disks, magnetic disks, and flash memories.

### REFERENCE SIGNS LIST

10 . . . image encoding device 11 . . . A/D converter 12, 57 . . . screen rearrangement buffer 13 . . . subtraction unit 14 . . . orthogonal transform unit 15 . . . quantization unit 16 . . . lossless quantization unit 17, 51 . . . accumulation buffer 18 . . . rate control unit 21, 53 . . . inverse quantization unit 22, 54 . . . inverse orthogonal transform unit 23, 55 . . . addition unit 24, 56 . . . deblocking filter 25, 61 . . . frame memory 26, 62, 75 . . . selector 31, 71 . . . intra prediction unit 32 . . . motion prediction/compensation unit 33, 73 . . . block selection processing unit 34, 74 . . . predicted motion vector information generation unit 35 . . . predicted image/optimum mode selection unit 50 . . . image decoding device 52 . . . lossless decoding unit 58 . . . D/A converter 72 . . . motion compensation unit 80 . . . computer device 90 . . . television apparatus 92 . . . portable telephone device 94 . . . recording/reproducing apparatus 96 . . . imaging apparatus 321 . . . motion search unit 322 . . . cost function value calculation unit 323 . . . mode determination unit 324 . . . motion compensation processing unit 325 . . . motion vector/block size information buffer 341 . . . adjacent motion vector/block size information buffer 342, 743 . . . motion vector information processing unit 721 . . . block size information buffer 722 . . . difference motion vector information buffer 723 . . . motion vector information combining unit 724 . . . motion compensation processing unit 725 . . . motion vector information buffer 741 . . . temporary block size information buffer 742 . . . adjacent motion vector information buffer

1-16. (canceled)

17. An image processing device for performing decoding by using a motion compensation block defined in a hierarchical structure,
the image processing device comprising:
a block selection processing unit configured to select a block from processed adjacent motion compensation blocks in accordance with a block size of a current motion compensation block being subjected to the decoding and block sizes of the adjacent motion compensation blocks adjacent to the current motion compensation block; and
a predicted motion vector information generation unit configured to generate predicted motion vector information to be used in a decoding operation for motion vector information about the current motion compensation block, by using motion vector information about the block selected by the block selection processing unit.

18. The image processing device according to claim 17, wherein the block selection processing unit selects only an adjacent motion compensation block encoded in a block size of the same hierarchical level as the current motion compensation block.

19. The image processing device according to claim 18, wherein, when an adjacent motion compensation block located in an upper right position with respect to the current motion compensation block among three spatially adjacent motion compensation blocks to be used in a median prediction has been encoded in a block size of a different hierarchical level, the block selection processing unit uses an upper-left adjacent motion compensation block, instead of the upper-right adjacent motion compensation block.

20. The image processing device according to claim 19, wherein,
when all of the three adjacent motion compensation blocks have been encoded in a block size of the same hierarchical level as the current motion compensation block, the block selection processing unit selects the three adjacent motion compensation blocks, and
the predicted motion vector information generation unit performs the median prediction by using motion vector information about the selected three adjacent motion compensation blocks, to generate the predicted motion vector information.

21. The image processing device according to claim 19, wherein,
when two of the three adjacent motion compensation blocks have been encoded in a block size of the same hierarchical level as the current motion compensation block, the block selection processing unit selects the two adjacent motion compensation blocks having the block size of the same hierarchical level, and
the predicted motion vector information generation unit generates the predicted motion vector information by using a predicted motion vector that is the mean value of motion vectors indicated by motion vector information about the selected two adjacent motion compensation blocks, instead of performing the median prediction.

22. The image processing device according to claim 19, wherein,
when two of the three adjacent motion compensation blocks have been encoded in a block size of the same hierarchical level as the current motion compensation block, the block selection processing unit selects the two adjacent motion compensation blocks having the block size of the same hierarchical level, and
the predicted motion vector information generation unit generates the predicted motion vector information by selecting motion vector information about one of the selected two adjacent motion compensation blocks, and generates identification information for identifying which motion vector information of the motion vector information about the two adjacent motion compensation blocks has been selected, instead of performing the median prediction.

23. The image processing device according to claim 22, further comprising
a lossless decoding unit configured to extract the identification information from compressed image information,
wherein, when two of the three adjacent motion compensation blocks have been encoded in a block size of the same hierarchical level as the current motion compensation block, the block selection processing unit selects the two adjacent motion compensation blocks having the block size of the same hierarchical level, and
the predicted motion vector information generation unit selects motion vector information from the motion vector information about the selected two adjacent motion compensation blocks based on the extracted identification information, and sets the selected motion vector information as the predicted motion vector information.

24. The image processing device according to claim 19, wherein,
when one of the three adjacent motion compensation blocks has been encoded in a block size of the same hierarchical level as the current motion compensation block, the block selection processing unit selects the one adjacent motion compensation block having the block size of the same hierarchical level, and
the predicted motion vector information generation unit sets the motion vector information about the selected one adjacent motion compensation block as the predicted motion vector information, instead of performing the median prediction.

25. The image processing device according to claim 19, wherein,
when none of the three adjacent motion compensation blocks has been encoded in a block size of the same hierarchical level as the current motion compensation block, the block selection processing unit does not perform a block selection, and,
when none of the adjacent motion compensation blocks has been selected, the predicted motion vector information generation unit sets information indicating a zero-vector as the predicted motion vector information, instead of performing the median prediction.

26. The image processing device according to claim 18, wherein
the block selection processing unit selects a temporally adjacent motion compensation block encoded in a block size of the same hierarchical level as the current motion compensation block, and
the predicted motion vector information generation unit sets motion vector information about the temporally adjacent motion compensation block as the predicted motion vector information.

27. The image processing device according to claim 26, wherein
the block selection processing unit selects, from a spatially adjacent motion compensation block to be used in a median prediction and the temporally adjacent motion compensation block, an adjacent motion compensation block encoded in a block size of the same hierarchical level as the current motion compensation block, and
the predicted motion vector information generation unit selects spatially predicted motion vector information or temporally predicted motion vector information, and sets the selected predicted motion vector information as the predicted motion vector information, the spatially predicted motion vector information having being generated based on motion vector information about the spatially adjacent motion compensation block, the temporally predicted motion vector information being motion vector information about the temporally adjacent motion compensation block.

28. The image processing device according to claim 27, wherein the predicted motion vector information generation unit sets the spatially predicted motion vector information as the predicted motion vector information when only the spatially predicted motion vector information is generated, and sets the temporally predicted motion vector information as the predicted motion vector information when only the temporally predicted motion vector information is generated.

29. The image processing device according to claim 28, wherein, when neither the spatially predicted motion vector information nor the temporally predicted motion vector information is generated, the predicted motion vector information generation unit sets information indicating a zero-vector as the predicted motion vector information.

30. The image processing device according to claim 27, wherein the predicted motion vector information generation unit generates identification information for identifying which of the spatially predicted motion vector information and the temporally predicted motion vector information has been selected.

31. The image processing device according to claim 30, further comprising
a lossless decoding unit configured to extract the identification information from compressed image information,
wherein the block selection processing unit selects, from the temporally adjacent motion compensation block and the spatially adjacent motion compensation block, an adjacent motion compensation block encoded in a block size of the same hierarchical level as the current motion compensation block, and
the predicted motion vector information generation unit sets the spatially predicted motion vector information as the predicted motion vector information when the extracted identification information indicates that the spatially predicted motion vector information has been selected, and sets the motion vector information about the temporally adjacent motion compensation block as the predicted motion vector information when the extracted identification information indicates that the temporally predicted motion vector information has been selected, the spatially predicted motion vector information having being generated based on the motion vector information about the spatially adjacent motion compensation block.

32. An image processing method for performing decoding by using a motion compensation block defined in a hierarchical structure in an image processing device,
the image processing method comprising the steps of:
selecting a block from processed adjacent motion compensation blocks in accordance with a block size of a current motion compensation block being subjected to the decoding and block sizes of the adjacent motion compensation blocks adjacent to the current motion compensation block; and
generating predicted motion vector information to be used in a decoding operation for motion vector information about the current motion compensation block, by using motion vector information about the selected block.

33. An image processing device for performing encoding by using a motion compensation block defined in a hierarchical structure,
the image processing device comprising:
a block selection processing unit configured to select a block from processed adjacent motion compensation blocks in accordance with a block size of a current motion compensation block being subjected to the encoding and block sizes of the adjacent motion compensation blocks adjacent to the current motion compensation block; and
a predicted motion vector information generation unit configured to generate predicted motion vector information to be used in an encoding operation for motion vector information about the current motion compensation block, by using motion vector information about the block selected by the block selection processing unit.

34. An image processing method for performing encoding by using a motion compensation block defined in a hierarchical structure in an image processing device,
the image processing method comprising the steps of:
selecting a block from processed adjacent motion compensation blocks in accordance with a block size of a current motion compensation block being subjected to the encoding and block sizes of the adjacent motion compensation blocks adjacent to the current motion compensation block; and
generating predicted motion vector information to be used in an encoding operation for motion vector information about the current motion compensation block, by using motion vector information about the selected block.
